(19) United States
(12) Patent Application Publication
(10) Pub. No.: US 2022/0034344 A1
(43) Pub. Date: Feb. 3, 2022

(54) FLOATING FIXING COMPONENT AND MOUNTING METHOD THEREOF

(71) Applicant: FIVETECH TECHNOLOGY INC., New Taipei City (TW)

(72) Inventor: TING-JUI WANG, New Taipei City (TW)

(21) Appl. No.: 17/381,220

(22) Filed: Jul. 21, 2021

(30) Foreign Application Priority Data
Aug. 3, 2020 (TW) 109126190

(51) Int. Cl. F16B 5/02

(52) U.S. Cl. CPC F16B 5/0258; F16B 5/0208

(57) ABSTRACT

A floating fixing component and a mounting method thereof are introduced. The floating fixing component includes at least a stop section and an application section. The stop section is used to abut against an object to prevent the floating fixing component from separating from the object. The floating fixing component and the object have a floating space existed between them, such that the floating fixing component can float and shift on and relative to the object. With these arrangements, the floating fixing component can be mounted to an object while the application section can be fastened to or disconnected from another object. In this manner, at least two objects can be repeatedly and quickly connected to and disconnected from one another.

### CROSS-REFERENCE TO RELATED APPLICATION

This non-provisional application claims priority under 35 U.S.C. § 119(a) on Patent Application No(s). 109126190 filed in Taiwan, R.O.C. on Aug. 3, 2020, the entire contents of which are hereby incorporated by reference.

### BACKGROUND OF THE INVENTION

### 1. Field of the Invention

The present disclosure relates to a floating fixing component and a mounting method thereof, and more particularly, to a floating fixing component and a mounting method thereof that enable at least two objects to be repeatedly and quickly connected to and disconnected from one another.

### 2. Description of the Related Art

Generally, when at least one object is to be connected to another object, screws are often used to directly lock the two objects together.

However, while the conventional fastening method enables fixed and non-easily-separable connection of at least one object to another object, the two objects so connected might still become unstably movable relative to one another.

### BRIEF SUMMARY OF THE INVENTION

An objective of the present disclosure is to provide a floating fixing component and a mounting method thereof, so that at least two objects can be repeatedly and quickly connected to and disconnected from one another.

To achieve at least the above objective, the floating fixing component according to the present disclosure includes at least a stop section and an application section. The stop section is used to abut against an object to prevent the floating fixing component from separating from the object. The floating fixing component and the object have a floating space existed between them, such that the floating fixing component can float and shift on and relative to the object.

In an embodiment, the above floating fixing component further includes an anti-rotation section corresponding to a matching anti-rotation section on the object, such that the anti-rotation section and the matching anti-rotation section are not rotatable relative to one another. The stop section abuts against the object to prevent the floating fixing component from separating from the object. The floating space is existed between the anti-rotation section and the matching anti-rotation section, such that the floating fixing component can float and shift on and relative to the object.

In an embodiment, the floating fixing component further includes at least one engaging section, which has a material storage space and a pressing section. The engaging section has rigidity higher than that of the stop section, and a partial material of the stop section is forced or flows into the material storage space of the engaging section when a force is applied to the stop section, such that the stop section is engaged with the engaging section.

In an embodiment, the floating fixing component further includes at least one engaging section, which provides a material storage space. A partial material of the stop section is forced or flows into the material storage space of the engaging section when a force is applied to the engaging section, such that the stop section is engaged with the engaging section.

In an embodiment, the floating fixing component further includes at least one engaging section. A force can be applied to the engaging section; such the engaging section under pressure is expanded to form a material storage space for receiving a partial material of the stop section, bringing the stop section to engage with the engaging section.

In an embodiment, the floating fixing component further includes an engaging section. The engaging section can be connected to the stop section by riveting, expansion connecting, welding, elastically fastening, fastening or screwing. Alternatively, the engaging section and the stop section can be integrally formed.

In an embodiment, the floating fixing component further includes at least one engaging section that provides a material storage space. Wherein the stop section is sideward engaged with the material storage space of the engaging section.

In an embodiment, the floating fixing component further includes at least one engaging section that provides a material storage space. Wherein the stop section is an elastic fastener having an open slot and can be pressed against the engaging section to expand the open slot and enter into the material storage space of the engaging section, such that the stop section is engaged with the engaging section.

In the floating fixing component, the application section can be differently configured as a female thread, a male thread, a column, a female fastener, a bore, a slot or a male fastener.

In an embodiment of the floating fixing component, the floating space has a size ranged between 0.01 mm and 1000 mm.

In an embodiment, the anti-rotation section and the matching anti-rotation section can be beveled, polygonal or slotted in shape, or can be any other shape that prevents the anti-rotation section and the matching anti-rotation section from rotating relative to one another.

In an embodiment of the floating fixing component, the stop section can be a plate provided with a through hole, a slot or a groove; or a washer; a sheet spring; a block or a fastener. Alternatively, the stop section 12 can be a sideward fastened plate provided with a through hole, a slot or a groove; a washer; a sheet spring; a block or a fastener.

In an embodiment, the floating fixing component further includes at least one engaging section. A force can be applied to the engaging section, such that the engaging section is expanded and deformed to press against the object.

In an embodiment of the floating fixing component, the application section can be a fastener, a grip or a handle.

A floating fixing component according to another embodiment of the present disclosure includes at least a stop section and an application section. The stop section is used to press against an object to prevent the floating fixing component from separating from the object. A floating space is existed between the stop section and the application section, such that the application section can float and shift on and relative to the stop section.

The method of mounting a floating fixing component of the present disclosure to an object is also provided. The floating fixing component includes an anti-rotation section and at least a stop section and an application section. The mounting method of the floating fixing component to an object includes the following steps: aligning the anti-rotation section with a matching anti-rotation section provided on the object, such that the anti-rotation section and the matching anti-rotation section are not rotatable relative to one another, and abutting the stop section against the object to prevent the floating fixing component from separating from the object. Wherein, a floating space is existed between the anti-rotation section and the matching anti-rotation section after the floating fixing component has been mounted to the object, such that the floating fixing component can float and shift on and relative to the object.

In a further embodiment of the present disclosure, the floating fixing component includes an application section and a retaining section. The retaining section is provided on an end of the application section and includes a neck portion for fastening to, coupling with or holding on a target object. A floating space is existed between the retaining section and the target object, such that the floating fixing component can float and shift relative to the target object.

In the above floating fixing component, the application section is provided on another end with a fixed connection section.

In an embodiment of the floating fixing component, the retaining section is first extended through an expanded receiving area provided on the target object and then the neck portion of the retaining section is moved into a narrowed holding area provided on the target object.

In an embodiment of the floating fixing component, after the neck portion of the retaining section is moved into and held to the narrowed holding area of the target object, a fastening element is fastened to or threaded into the fixed connection portion of the application section to connect the application section to the target object.

In an embodiment of the present disclosure, the floating fixing component is provided on two ends with a retaining section each; and a target object is provided with two expanded receiving areas and two narrowed holding areas. To use the floating fixing component, first move the two retaining sections into the two expanded receiving areas of the target object. Then, move the neck portions into the narrowed holding areas of the target object. At this point, the floating fixing component is mounted to the target object.

In an embodiment of the floating fixing component, the retaining sections are first extended through the expanded receiving areas on the target object and then the neck portions of the retaining sections are moved into two intermediate areas on the target object, and finally clamped portions of the retaining sections are moved into the narrowed holding areas on the target object.

In an embodiment, the floating fixing component includes a retaining section having an abutting member. After the retaining section and the abutting member are moved into a clamping area on the target object, the abutting member abuts against the application section and the target object, or abuts against the retaining section and the target object.

In an embodiment of the floating fixing component, the neck portion has a stop portion, which is located in the application section with a pressing element provided between the application section and the stop portion. The pressing element has an end pressed against the application section and another end pressed against the stop portion, such that the neck portion is normally located at a retracted position relative to the application section.

In the above embodiment of the floating fixing component, an external force can be applied to the retaining section to pull out the neck portion from the retracted position for moving into the clamping area on the target object.

In the above embodiment of the floating fixing component, the neck portion has a stop portion, which is located in the application section with a pressing element provided between the application section and the stop portion. The pressing element has an end pressed against the application section and another end pressed against the stop portion, such that the neck portion is normally located at a retracted position relative to the application section.

In an embodiment of the above floating fixing component, an external force can be applied to the retaining section to pull out the neck portion from the retracted position for moving it into an intermediate area on the target object and then move a clamped portion into the narrowed holding area on the target object.

In an embodiment of the floating fixing component, the stop portion is set in a seat portion of the application section, and the seat portion is assembled to the application section.

In an embodiment of the floating fixing component, the pressing element can be a sheet spring, an elastic column, a spring or an elastic fastener.

In an embodiment of the floating fixing component, the retaining section has a neck portion that provides a material storage space. An external force can be applied to the application section or the retaining section, such that a partial material of the target object is forced or flows into the material storage space. Thus, the floating fixing component is connected to the target object.

In an embodiment of the above floating fixing component, the external force can be further applied to a shoulder portion of the application section.

In an embodiment of the floating fixing component, an external force can be applied to the retaining section to thereby form a neck portion on the retaining section. The neck portion provides a material locking space for locking a partial material of the target object thereto, such that the floating fixing component is mounted to the target object.

In an embodiment of the floating fixing component, the retaining section is in the form of a neck structure, and a weldable surface is provided on the application section or the neck structure for welding to a fixing area on the target object.

In the above floating fixing component, the application section or the retaining section is welded to the fixing area of the target object using tin solder. And, the fixing area can be an opening, an open slot, a planar surface, a recess or a protrusion.

In an embodiment of the present disclosure, the floating fixing component is picked up using a tool and then put down on the target object for mounting to the target object.

In an embodiment, the floating fixing component is picked up using a tool and then put down on the target object at a desired mounting position. Alternatively, the floating fixing component is picked up using a tool and then compared with a mounting position on the target object using a comparison device, so that the floating fixing component is precisely put down on the desired mounting position on the target object.

In the above embodiment, the floating fixing component is placed on a carrier. The carrier has or has not a cover.

In an embodiment of the floating fixing component, the application section includes a seat portion, which is coupled or connected to the retaining section and the neck portion.

In the above floating fixing component, the seat portion is assembled to or movably connected to the application section, or is held in the application section via a connecting element.

In an embodiment of the floating fixing component, the application section includes a material forcing portion for forcing a partial material of the target object into the neck portion.

In an embodiment, the floating fixing component includes at least one anti-slip section to facilitate firm handling of the floating fixing component with a hand.

In an embodiment of the floating fixing component, the narrowed holding area on the target object can be a protrusion, a recess or a stop structure for interfering with or abutting against the application section, the retaining section or the floating fixing component.

In an embodiment of the floating fixing component, the intermediate area on the target object can be a protrusion, a recess or a stop structure for interfering with or abutting against the application section, the retaining section, the clamped portion or the floating fixing component.

In an embodiment of the floating fixing component, the neck portion includes an operating section extended beyond the floating fixing component for operating the retaining section.

In an embodiment, the floating fixing component includes two retaining sections. One of the two retaining sections is extended into an expanded receiving area of the target object and then moved into an intermediate area of the target object, and finally moved into a narrowed holding area of the target object. The other retaining section is extended into another expanded receiving area of the target object and then moved into another narrowed holding area of the target object.

In an embodiment, the floating fixing component includes two retaining sections for separately moving into two expanded receiving areas, two intermediate areas and two narrowed holding areas formed on the target object.

In an embodiment, the floating fixing component includes a retaining section and a fixed connection portion. The retaining section can be extended through an expanded receiving area on a target object and then sequentially moved into an intermediate area and a narrowed holding area of the target object. The fixed connection can be fixedly connected to the target object.

In an embodiment, the floating fixing component further includes at least one fastening section. After the retaining section is moved into at least one narrowed holding area of the target object, the at least fastening section is moved into at least one locating area of the target object, such that the retaining section is restricted from moving laterally, vertically or rotationally relative to the target object. Alternatively, the fastening section is abutted against or interfered with a surface of the target object to thereby restrict the retaining section from moving laterally, vertically or rotationally relative to the target object.

In an embodiment, the floating fixing component further includes at least one fastening section. The retaining section is first moved into at least one narrowed holding area of the target object, and then the at least fastening section is moved into at least one locating area of the target object, such that the retaining section is restricted from moving laterally, vertically or rotationally relative to the target object. Alternatively, the fastening section is abutted against or interfered with a surface of the target object to thereby restrict the retaining section from moving laterally, vertically or rotationally relative to the target object.

In the above embodiment of the floating fixing component, the fastening section is an elastic fastener having an elastic fastening arm.

In an embodiment of the floating fixing component, the locating area on the target object is communicable with the narrowed holding area. Alternatively, the locating area is independent of the narrowed holding area.

In an embodiment of the floating fixing component, the retaining section has a width smaller than that of the expanded receiving area, and the narrowed holding area has a width larger than that of the neck portion and smaller than that of the retaining section.

In an embodiment of the floating fixing component, the retaining section has a width smaller than that of the expanded receiving area, and the narrowed holding area or the intermediate area has a width larger than that of the neck portion or the clamped portion and smaller than that of the retaining section.

In an embodiment of the floating fixing component, the application section or the retaining section includes an interfering portion for interfering with or abutting against the target object.

In an embodiment of the floating fixing component, the pressing element can be integrally formed with the floating fixing component.

In an embodiment of the floating fixing component, the pressing element is connected to the floating fixing component via a connecting segment.

In an embodiment of the floating fixing component, the fixed connection portion is integrally formed with the floating fixing component. Alternatively, the fixed connection portion can be bolted, riveted, fastened, expansion connected, welded, screwed, snapped or thermally sealed to the floating fixing component. Alternatively, the fixed connection portion can be integrated with the floating fixing component through in-mold injection molding.

In an embodiment of the floating fixing component, the fixed connection portion is externally provided with an anti-rotation section to prevent the fixed connection portion connected to the application section from separating from or rotating relative to a target object.

In an embodiment of the floating fixing component, the application section or the retaining section can be put in an electrically conductive solution, and a layer of anti-corrosion substance is transferred by the electrically conductive solution to the head portion or the application section and is attached thereto.

In an embodiment of the floating fixing component, the application section, the retaining section, the electrically conductive solution, or the anti-corrosion substance is conductive when an electric current is applied thereto, such that the anti-corrosion substance can be transferred to attach to the head portion or the application section.

In another embodiment of the present disclosure, the floating fixing component includes a retaining section and two stop sections. The stop sections can be extended through an expanded receiving area on a first object and then the retaining section is moved into a narrowed holding area on the first object, such that the floating fixing component is limited by the two stop sections from moving relative to the first object. The retaining section has an outer diameter smaller than that of the narrowed holding area, and the stop section has an outer diameter larger than that of the narrowed holding area.

In an embodiment of the embodiment, the floating fixing component includes an application section, which is movably assembled to a head portion or a second retaining section.

In the above embodiment, the head portion and the application section have an elastic element disposed between them to elastically stop them from moving.

In an embodiment of the embodiment, the floating fixing component includes an application section, which is a floating member.

In the above embodiment, the application section is a floating member with a retaining section provided on each of two ends thereof. Alternatively, the application section is a floating member with a retaining section provided on only one end thereof.

In an embodiment, the floating fixing component further includes a stop member set in or pressed against the expanded receiving area or the narrowed holding area on a first object to prevent the retaining section from separating from the expanded receiving area or the narrowed holding area.

In an embodiment of the floating fixing component, the stop member is configured to include a flange portion. The flange portion has a size larger than that of the expanded receiving area or the narrowed holding area, such that the flange portion can be retained or fastened to the expanded receiving area, the narrowed holding area or any area of the first object.

In the above embodiment, the stop member can also include an application portion. The application portion has a size larger than, equal to or smaller than that of the expanded receiving area or the narrowed holding area.

In an embodiment of the floating fixing component, the stop section can be extended through a first object and a second object, and then be moved into a narrowed holding area of the first object and retained to the second object.

In an embodiment of the floating fixing component, the second retaining section is in the form of a material receiving slot. When the floating fixing component applies an external force to the second object, a partial material of the second object is forced or flows into the material receiving slot provided by the second retaining section.

In an embodiment of the floating fixing component, the second retaining section is an expansion connection section, which is deformed to engage with the second object when an external force is applied to the second retaining section.

In an embodiment of the floating fixing component, the second retaining section is a weldable section for welding to the second object.

In an embodiment of the floating fixing component, the stop member includes a connecting section, which can be assembled to or integrally formed with the floating fixing component.

In an embodiment of the present disclosure, the floating fixing component further includes a stop member. After the retaining section of the floating fixing component has been moved into the narrowed holding area on the target object, the stop member is then set in or abutted against the expanded receiving area or the narrowed holding area of the target object to block the expanded receiving area or the narrowed holding area, such that the retaining section is prevented from separating from the expanded receiving area or the narrowed holding area.

In an embodiment of the floating fixing component, a portion of the expanded receiving area located between the stop section and the stop member or a portion of the narrowed holding area located between the retaining section and the stop member forms a floating space, such that the retaining section or the stop section is movable in the floating space.

In the above embodiment, the floating space defines a movement track of the floating fixing component.

In an embodiment of the floating fixing component, an external force is applied to an expanded receiving area or a narrowed holding area of a first object to form a deformed area, so as to block the expanded receiving area or the narrowed holding area and prevent the retaining section from moving out of the expanded receiving area or the narrowed holding area.

In the above embodiment, the retaining section is moved into the narrowed holding area before the external force is applied to the expanded receiving area or the narrowed holding area to form the deformed area to block the same, such that the retaining section is prevented from moving out of the expanded receiving area or the narrowed holding area.

In the above embodiment, the deformed area and the stop section or the retaining section have a floating space existed between them, such that the retaining section or the stop section can float and shift in the floating space.

In the above embodiment, the floating space defines the movement track of the floating fixing component.

In an embodiment, the floating fixing component includes two stop sections for limiting the first object to between the two stop sections.

In an embodiment, the floating fixing component further includes a stop member for stopping the floating fixing component from floating and shifting in the floating space, such that the floating fixing component is limited to the first object without separating therefrom.

In an embodiment of the floating fixing component, the retaining section has an abutting member fitted therearound or coupled therewith. The abutting member is abutted against a narrowed holding area on an object or abutted against a clamped area of the object.

In the above embodiment, the abutting member includes a guide portion for guiding the abutting member to engage with or abut against the narrowed holding area.

In the above embodiment, the abutting member includes a stepped portion, which can be engaged with the clamping area or the narrowed holding area.

In the above embodiment, the stepped portion has a width larger than or smaller than that of the narrowed holding area, or the stepped portion has a width smaller than that of the clamping area, such that the abutting member can be held in place in the clamping area.

In the above embodiment, the abutting member further includes an elastic element, which has an end pressed against the abutting member and another end pressed against the stop section.

In an embodiment of the floating fixing component, the application section is bolt-connected to the retaining section via a coupling element.

In an embodiment, the floating fixing component further includes a stop member, which can be used to abut against an expanded receiving area on a first object or a retaining section on the floating fixing component, so as to prevent the retaining section from separating from the expanded receiving area or a narrowed holding area on the first object.

In an embodiment, the retaining section of the floating fixing component is provided with an anti-rotation section corresponding to a matching anti-rotation section provided on the target object.

In an embodiment, the retaining section and the target object have a floating space existed between them, such that the floating fixing component can float and shift in the floating space relative to the target object.

In a further embodiment of the present disclosure, the floating fixing component includes an expanded receiving area and a narrowed holding area. The expanded receiving area can be extended through a stop section on a first object and then the narrowed holding area can be moved to engage with a retaining section on the first object, such that the stop section restricts the floating fixing component from moving relative to the object.

The floating fixing component according to the present disclosure can be mounted to or used with a server, a server chassis, a chassis, a printed circuit board (PCB), a mother board, a housing, a cabinet, a rail member, a container, a support, a storage, a column, a planar surface, a recess, a protrusion, a cambered surface or a curved surface.

With the present disclosure, the floating fixing component can be mounted to an object while the application section of the floating fixing component can be fastened to or removed from another object, such that at least two objects can be repeatedly and quickly connected to or disconnected from one another.

### BRIEF DESCRIPTION OF THE DRAWINGS

FIG. 1 is an exploded perspective view of a floating fixing component according to a first embodiment of the present disclosure.

FIG. 2 is an assembled view of FIG. 1.

FIG. 3 illustrates a floating fixing component according to a second embodiment of the present disclosure and the manner of mounting it to an object.

FIG. 4 illustrates a floating fixing component according to a third embodiment of the present disclosure and the manner of mounting it an object.

FIG. 5 shows a floating fixing component according to a fourth embodiment of the present disclosure and the manner of mounting it to an object.

FIG. 6 shows a floating fixing component according to a fifth embodiment of the present disclosure and the manner of mounting it to an object.

FIG. 7 illustrates a floating fixing component according to a sixth embodiment of the present disclosure and the manner of mounting it to an object.

FIG. 8 illustrates a floating fixing component according to a seventh embodiment of the present disclosure and the manner of assembling its sections together.

FIG. 9 illustrates the floating fixing component according to the seventh embodiment of the present disclosure in an assembled state.

FIG. 10 illustrates different configurations available for an application section of the floating fixing component according to the present disclosure.

FIG. 11 illustrates a floating fixing component according to an eighth embodiment of the present disclosure.

FIG. 12 illustrates the manner of mounting the floating fixing component according to the eighth embodiment of the present disclosure to an object.

FIG. 13 illustrates the manner of mounting a floating fixing component according to a ninth embodiment of the present disclosure and the manner of mounting it to an object.

FIG. 14 illustrates a floating fixing component according to a tenth embodiment of the present disclosure and the manner of mounting it to an object.

FIG. 15 is a sectional view of a floating fixing component according to an eleventh embodiment of the present disclosure.

FIG. 16 is an exploded perspective view illustrating the manner of mounting the floating fixing component according to the eleventh embodiment of the present disclosure to a target object.

FIG. 17 shows an exploded and an assembled side view illustrating the manner of mounting the floating fixing component according to the eleventh embodiment of the present disclosure to the target object.

FIG. 18 is an assembled perspective view of FIG. 16 illustrating the floating fixing component according to the eleventh embodiment of the present disclosure is mounted to the target object.

FIG. 19 is an assembled rear view illustrating the floating fixing component according to the eleventh embodiment of the present disclosure and the target object.

FIG. 20 is a sectional side view of a floating fixing component according to a twelfth embodiment of the present disclosure.

FIG. 21 is an exploded perspective view illustrating the manner of mounting the floating fixing component according to the twelfth embodiment of the present disclosure a target object.

FIG. 22 shows an exploded and an assembled side view illustrating a floating fixing component according to a thirteenth embodiment of the present disclosure and the manner of mounting it to a target object.

FIG. 23 is an assembled perspective view illustrating the floating fixing component according to the thirteenth embodiment of the present disclosure and the target object.

FIG. 24 is a structural view of a floating fixing component according to a fourteenth embodiment of the present disclosure and a target object, to which the floating fixing component is mounted.

FIG. 25 illustrates the manner of mounting the floating fixing component according to the fourteenth embodiment of the present disclosure to the target object.

FIG. 26 is a structural view of a floating fixing component according to a fifteenth embodiment of the present disclosure and a target object, to which the floating fixing component is mounted.

FIG. 27 illustrates the manner of mounting the floating fixing component according to the fifteenth embodiment of the present disclosure to the target object.

FIG. 28 illustrates a floating fixing component according to a sixteenth embodiment of the present disclosure and the manner of mounting it to a target object.

FIG. 29 illustrates a floating fixing component according to a seventeenth embodiment of the present disclosure and the manner of mounting it to a target object.

FIG. 30 illustrates a floating fixing component according to an eighteenth embodiment of the present disclosure and the manner of mounting it to a target object.

FIG. 31 illustrates a floating fixing component according to a nineteenth embodiment of the present disclosure and the manner of mounting it to a target object.

FIG. 32 illustrates a floating fixing component according to a twentieth embodiment of the present disclosure and the manner of mounting it to a target object.

FIG. 33 illustrates a floating fixing component according to a twenty-first embodiment of the present disclosure and the manner of mounting it to a target object.

FIG. 34 illustrates a floating fixing component according to a twenty-second embodiment of the present disclosure and the manner of mounting it to a target object.

FIG. 35 illustrates a floating fixing component according to a twenty-third embodiment of the present disclosure and the manner of mounting it to a target object.

FIG. 36 illustrates a variant of the floating fixing component according to the twenty-third embodiment of the present disclosure and the manner of mounting it to a target object.

FIG. 37 illustrates another variant of the floating fixing component according to the twenty-third embodiment of the present disclosure and the manner of mounting it to a target object.

FIG. 38 is an exploded perspective view illustrating a floating fixing component according to a twenty-fourth embodiment of the present disclosure and the manner of mounting it to a target object.

FIG. 39 is a fragmentary, assembled view of the floating fixing component of the twenty-fourth embodiment illustrating the manner of mounting it to the target object.

FIG. 40 illustrates the manner of forming a floating fixing component according to a twenty-fifth embodiment of the present disclosure.

FIG. 41 illustrates a floating fixing component according to a twenty-sixth embodiment of the present disclosure and the manner of mounting it to a target object.

FIG. 42 is a perspective view of a floating fixing component according to a twenty-seventh embodiment of the present disclosure.

FIG. 43 shows different configurations available for an outer surface of a fixed connection portion of the floating fixing component according to the present disclosure.

FIG. 44 is a perspective view of a floating fixing component according to a twenty-eighth embodiment of the present disclosure.

FIG. 45 is a sectional view of a floating fixing component according to a twenty-ninth embodiment of the present disclosure.

FIG. 46 is a perspective view of a floating fixing component according to a thirtieth embodiment of the present disclosure and a first object, to which the floating fixing component is mounted.

FIG. 47 shows the manner of mounting the floating fixing component of the thirtieth embodiment to the first object.

FIG. 48 is a sectional view of a floating fixing component according to a thirty-first embodiment of the present disclosure.

FIG. 49 is a sectional view of a floating fixing component according to a thirty-second embodiment of the present disclosure.

FIG. 50 is a sectional view of a floating fixing component according to a thirty-third embodiment of the present disclosure.

FIG. 51 is a sectional view of a floating fixing component according to a thirty-fourth embodiment of the present disclosure.

FIG. 52 is a perspective view of a floating fixing component according to a thirty-fifth embodiment of the present disclosure.

FIG. 53 is a perspective view showing the manner of mounting the floating fixing component of the thirty-fifth embodiment to a first object.

FIG. 54 includes side views showing the manner of mounting the floating fixing component of the thirty-fifth embodiment to the first object.

FIG. 55 is a perspective view of a floating fixing component according to a thirty-sixth embodiment of the present disclosure.

FIG. 56 is an exploded perspective view showing the manner of mounting the floating fixing component according to the thirty-sixth embodiment of the present disclosure to a first object.

FIG. 57 includes side views showing the manner of mounting the floating fixing component according to the thirty-sixth embodiment of the present disclosure to the first object.

FIG. 58 is an exploded perspective view showing a floating fixing component according to a thirty-seventh embodiment of the present disclosure and the manner of mounting it to a first and a second object.

FIG. 59 includes side views showing the manner of mounting the floating fixing component according to the thirty-seventh embodiment of the present disclosure to the first and second objects.

FIG. 60 is an assembled perspective view showing the floating fixing component according to the thirty-seventh embodiment of the present disclosure and the first and second objects, to which the floating fixing component is mounted.

FIG. 61 shows different configurations available for a second retaining section of the floating fixing component according to the present disclosure.

FIG. 62 shows different configurations available for a stop member of the floating fixing component according to the present disclosure.

FIG. 63 illustrates a floating fixing component according to a thirty-eighth embodiment of the present disclosure and the manner of mounting it to a first object.

FIG. 64 illustrates a floating fixing component according to a thirty-ninth embodiment of the present disclosure and the manner of mounting a second retaining section thereof to a second object.

FIG. 65 illustrates a floating fixing component according to a fortieth embodiment of the present disclosure and the manner of mounting a second retaining section thereof to a second object.

FIG. 66 illustrates a floating fixing component according to a forty-first embodiment of the present disclosure and the manner of mounting a second retaining section thereof to a second object.

FIG. 67 illustrates a floating fixing component according to a forty-second embodiment of the present disclosure and the manner of mounting it to a first object.

FIG. 68 illustrates a floating fixing component according to a forty-third embodiment of the present disclosure and the manner of mounting it to a first object.

FIG. 69 illustrates a floating fixing component according to a forty-fourth embodiment of the present disclosure and the manner of mounting it to a first object.

FIG. 70 illustrates a floating fixing component according to a forty-fifth embodiment of the present disclosure and the manner of mounting it to a first object.

FIG. 71 is an exploded perspective view showing a first object and a second object, to which a floating fixing component according to a forty-sixth embodiment of the present disclosure is mounted.

FIG. 72 illustrates a floating fixing component according to a forty-seventh embodiment of the present disclosure and the manner of mounting it to a first and a second object.

FIG. 73 illustrates a floating fixing component according to a forty-eighth embodiment of the present disclosure.

FIG. 74 illustrates a floating fixing component according to a forty-ninth embodiment of the present disclosure and the manner of mounting it to a first object.

### DETAILED DESCRIPTION OF THE INVENTION

To facilitate understanding of the objects, characteristics and effects of this present disclosure, embodiments together with the attached drawings for the detailed description of the present disclosure are provided. It is noted the present disclosure can be implemented or applied in other embodiments, and many changes and modifications in the described embodiments can be carried out without departing from the spirit of the disclosure, and it is also understood that the preferred embodiments are only illustrative and not intended to limit the present disclosure in any way.

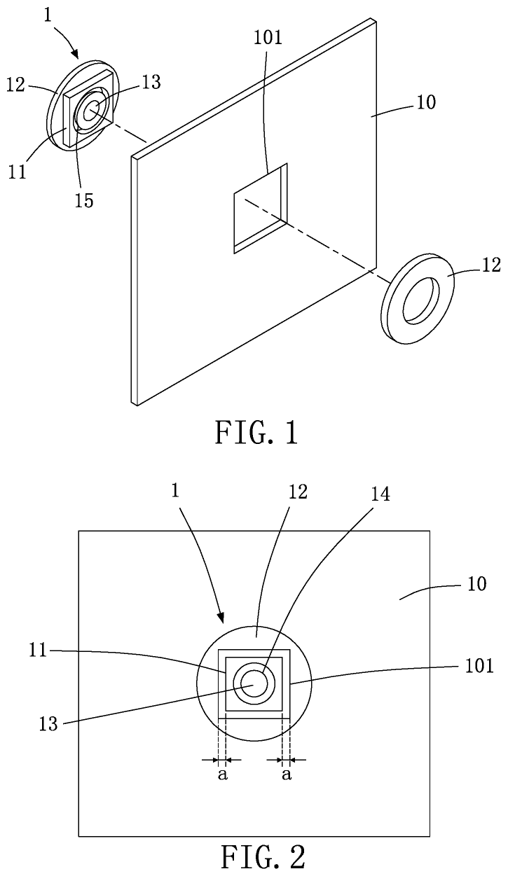

The present disclosure relates to a floating fixing component 1 and a mounting method thereof. Please refer to FIGS. 1 and 2. According to a first embodiment of the present disclosure, the floating fixing component 1 includes at least a stop section 12 and an application section 13. The application section 13 can be embodied as a fastener. The stop section 12 is used to abut against an object 10 to prevent the floating fixing component 1 from separating from the object 10. The floating fixing component 1 and the object 10 has a floating space “a” existed between them, such that the floating fixing component 1 can float and shift on and relative to the object 10.

In the first embodiment of the present disclosure, the floating fixing component 1 further includes an anti-rotation section 11 corresponding to a matching anti-rotation section 101 on the object 10, such that the anti-rotation section 11 and the matching anti-rotation section 101 are not rotatable relative to one another. The stop section 12 is abutted against the object 10 to prevent the floating fixing component 1 from separating from the object 10. The floating space “a” is existed between the anti-rotation section 11 and the matching anti-rotation section 101, such that the floating fixing component 1 can float and shift on and relative to the object 10.

The floating fixing component 1 can be mounted to or used with the object 10, which can be a server, a server chassis, a chassis, a printed circuit board (PCB), a mother board, a housing, a cabinet, a rail member, a container, a support, a storage, a column, a planar surface, a recess, a protrusion, a cambered surface or a curved surface. The mounting method of the floating fixing component 1 includes the steps of aligning the anti-rotation 11 with the matching anti-rotation section 101 of the object 10, such that the anti-rotation section 11 and the matching anti-rotation section 101 stop each other from rotating; and abutting the stop section 12 against the object 10, such that the floating fixing component 1 is prevented from separating from the object 10. After the floating fixing component 1 is mounted to the object 10, a floating space “a” is existed between the anti-rotation section 11 and the matching anti-rotation section 101. With the floating space “a”, the floating fixing component 1 can float and shift on the object 10.

When the floating fixing component 1 is mounted to the object 10, the application section 13 can be fastened to or removed from another object (not shown), and the floating space “a” allows the floating fixing component 1 to float and shift on the object 10, which in turn allows the application section 13 to be adjusted to a location suitable for fastening to another object. In this way, at least two objects can be connected to and disconnected from one another in a repeatable and quick manner.

In the first embodiment of the present disclosure, the floating space “a” has a size ranged between 0.01 mm and 1000 mm. Therefore, the application section 13 can be adjusted in response to different fastening states to the location suitable for fastening to another object. In this manner, the present disclosure can meet more requirements in actual application thereof.

In the first embodiment of the present disclosure, the stop section 12 can be a plate provided with a through hole, a slot or a groove; a washer; a sheet spring; a block or a fastener. Alternatively, the stop section 12 can be a sideward fastened plate provided with a through hole, a slot or a groove; a washer; a sheet spring; a block or fastener. With these arrangements, differently configured stop sections 12 can be selected for use in response to different mounting requirements.

In the first embodiment of the present disclosure, the floating fixing component 1 has at least one engaging section 14, which is coupled with the stop section 12 to enable mounting of the floating fixing component 1 to the object 10.

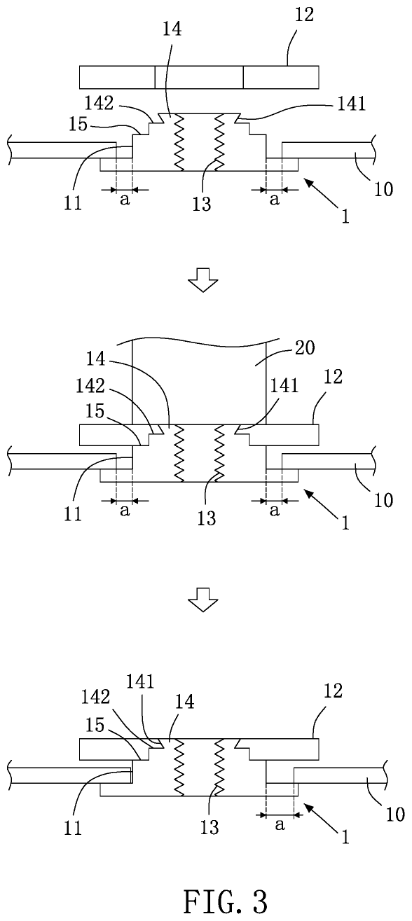

Please refer to FIG. 3. In a second embodiment of the present disclosure, the floating fixing component 1 has at least one engaging section 14, which includes a material storage space 141 and a pressing section 142. The engaging section 14 has rigidity higher than that of the stop section 12. A tool 20 can be used to apply a force on the stop section 12, such that a partial material of the stop section 12 under pressure is forced into or flows into the material storage space 141, bringing the stop section 12 to engage with the engaging section 14. In this manner, the floating fixing component 1 can be securely mounted to the object 10 to facilitate subsequent operation on the application section 13.

In the second embodiment of the present disclosure, the floating fixing component 1 includes a support section 15, on which the stop section 12 is disposed or placed. In this manner, the stop section 12 can be securely disposed or placed on the support section 15.

Further, in a variant of the second embodiment, the engaging section 14 can include only the material storage space 141 without the pressing section 142 (not shown). In this manner, a force can be similarly applied to the engaging section 14 for a partial material of the stop section 12 under pressure to enter or flow into the material storage space 141, such that the stop section 12 is engaged with the engaging section 141.

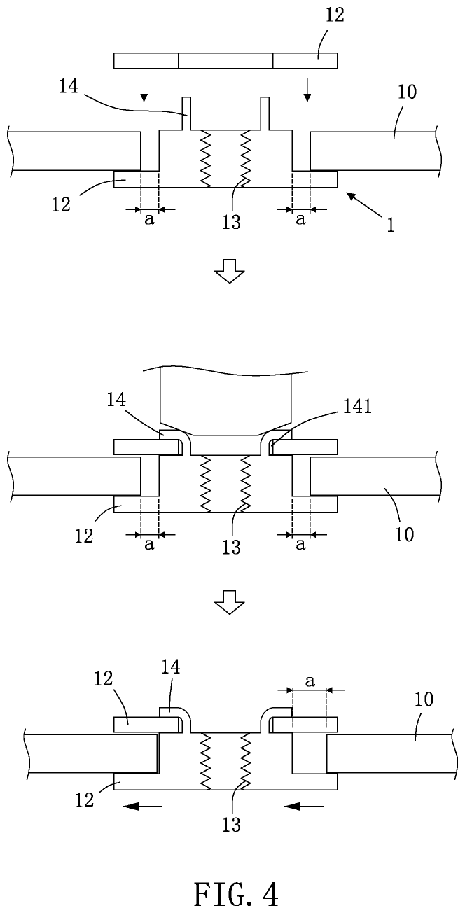

Please refer FIG. 4. In a third embodiment of the present disclosure, the floating fixing component 1 includes at least one engaging section 14. A force can be applied to the engaging section 14, such that the engaging section 14 under pressure is expanded to form the material storage space 141 for receiving a partial material of the stop section 12 and bringing the stop section 12 to engage with the engaging section 14. In this manner, the floating fixing component 1 can be securely mounted to the object 10 to facilitate subsequent operation on the application section 13.

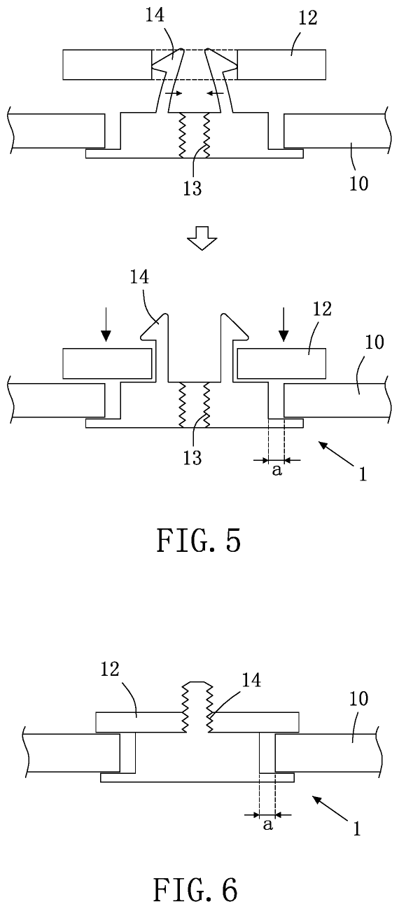

Please refer to FIGS. 5 and 6, in which floating fixing components 1 according to a fourth and a fifth embodiment, respectively, of the present disclosure are shown. In these two embodiments, the floating fixing components 1 respectively include at least one engaging section 14. In the fourth embodiment as shown in FIG. 5, the engaging section 14 and the stop section 12 are engaged with one another by means of riveting, expansion connection, welding or elastic fastening. In the fifth embodiment as shown in FIG. 6, the engaging section 14 and the stop section 12 are engaged with one another by means of fastening or screwing. Alternatively, the engaging section 14 and the stop section 12 can be otherwise integrally formed.

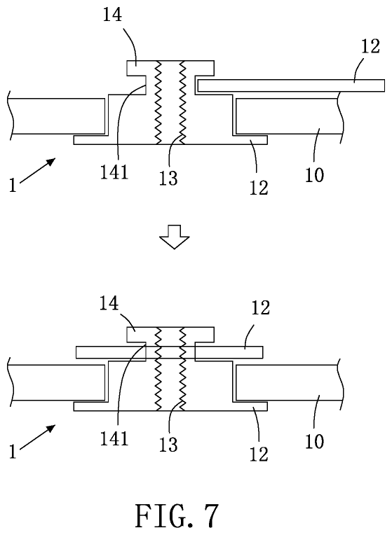

Please refer to FIG. 7. A floating fixing component 1 according to a sixth embodiment of the present disclosure includes at least one engaging section 14 that provides a material storage space 141, and a stop section 12 being sideward engaged with the material storage space 141 of the engaging section 14. In this manner, the floating fixing component 1 can be securely mounted to the object 10 to facilitate subsequent operation on the application section 13.

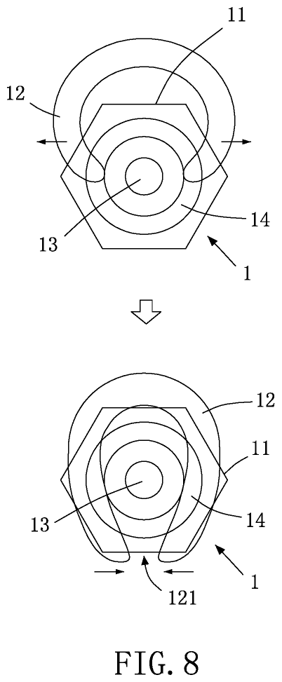

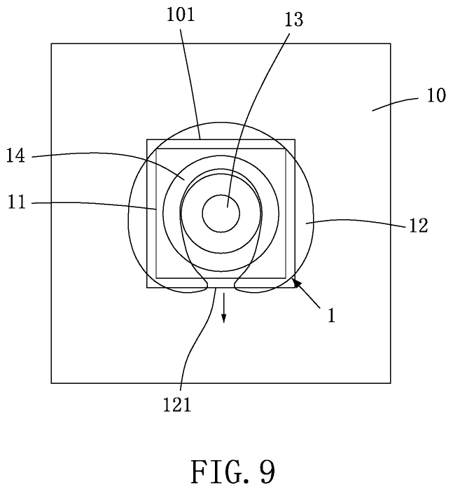

Please refer to FIGS. 8 and 9. A floating fixing component 1 according to a seventh embodiment of the present disclosure includes at least one engaging section 14 that provides a material storage space 141, and the stop section 12 is an elastic fastener having an open slot 121. The stop section 12 can be pressed at the open slot 121 against the engaging section 14 to expand the open slot 121. At this point, the stop section 121 can be moved into the material storage space 141 to engage with the engaging section 14. In this manner, the floating fixing component 1 can be securely mounted to the object 10 to facilitate subsequent operation on the application section 13, as shown in FIG. 9.

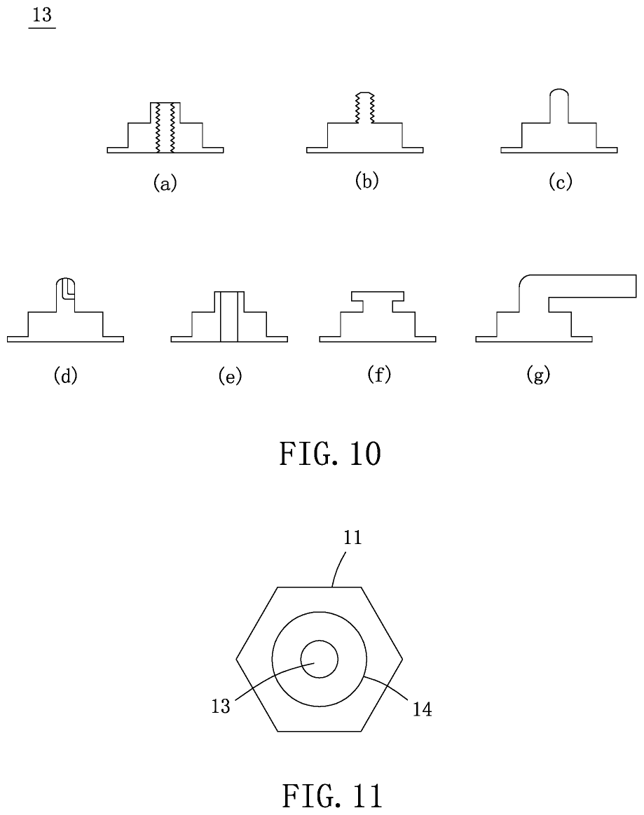

Please refer to FIG. 10. In the present disclosure, the application section 13 can be differently configured. For example, the application section 13 can be a female thread as shown in FIG. 10(a), a male thread as shown in FIG. 10(b), a column as shown in FIG. 10(c), a female fastener as shown in FIG. 10(d), a bore or a slot as shown in FIG. 10(e), a male fastener as shown in FIG. 10(f), or a handle as shown in FIG. 10(g). Differently configured application sections 13 can be selected for use according to actual need in fastening, so that the application section 13 can be easily connected to or disconnected from another object.

Please refer to FIGS. 11 and 12. In a floating fixing component 1 according to an eighth embodiment of the present disclosure, the anti-rotation section 11 and the matching anti-rotation section 101 can be beveled, polygonal or slotted in shape, or can be any other shape that prevents the anti-rotation section 11 and the matching anti-rotation section 101 from rotating relative to one another. Further, the floating fixing component 1 is provided at two opposite ends with an engaging section 14 each. One of the engaging sections 14 provides a material storage space 141 and allows a partial material of the stop section 12 under pressure to enter or flow into the material storage space 141 and accordingly, engage with the engaging section 14. The other engaging section 14 can be expanded when an external force is applied thereto to form another material storage space 141 for receiving a partial material of the stop section 12, bringing the stop section 12 to engage with the engaging section 14. In this manner, the floating fixing component 1 can be securely mounted to the object 10 to facilitate subsequent operation on the application section 13.

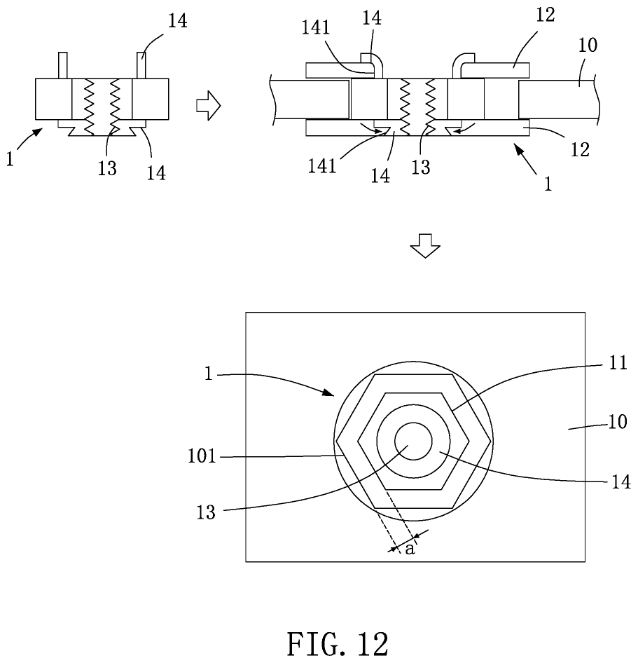

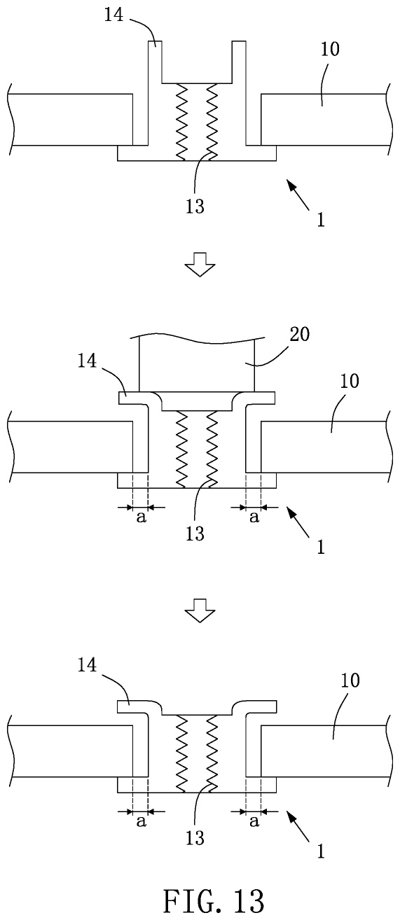

Please refer to FIG. 13, in which a floating fixing component 1 according to a ninth embodiment of the present disclosure and the manner of mounting it to an object 10 are shown. A tool 20 is used to apply a force to an engaging section 14; such that the engaging section 14 under the force is expanded and deformed to press against the object 10 with a floating space “a” existed between the floating fixing component 1 and the object 10. In this manner, the floating fixing component 1 can be securely mounted to the object 10 to facilitate subsequent operation on the application section 13.

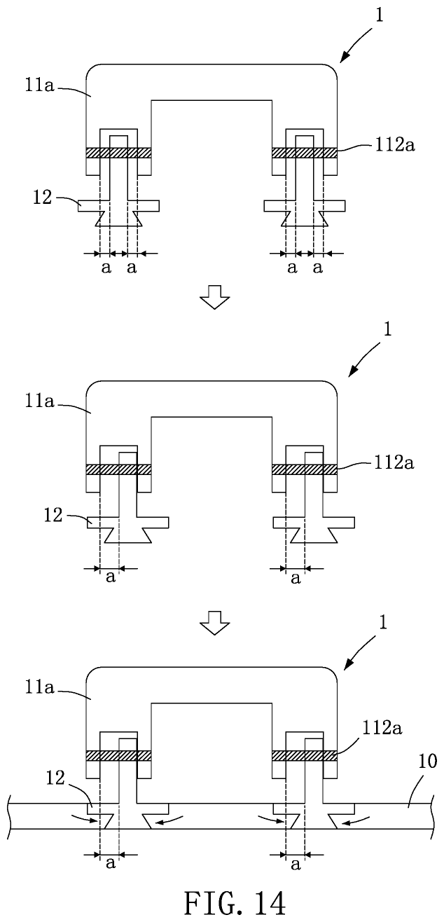

Please refer to FIG. 14, in which a floating fixing component 1 according to a tenth embodiment of the present disclosure and the manner of mounting it to an object 10 are shown. In the tenth embodiment, the floating fixing component 1 has an application section 11a that can be a grip or a handle for pressing a stop section 12 against the object 10 to prevent the floating fixing component 1 from separating from the object 10. Further, the stop section 12 and the application section 11a have a floating space “a” existed between them, such that the application section 11a can float and shift on and relative to the stop section 12.

In the tenth embodiment of the present disclosure, the application section 11a is movably connected to the stop section 12 via a connecting element 112a. In this embodiment, the connecting element 112a functions like an anti-rotation section and the stop section 12 functions like a matching anti-rotation section, such that the connecting element 112a and the stop section 12 are stopped from rotating relative to one another.

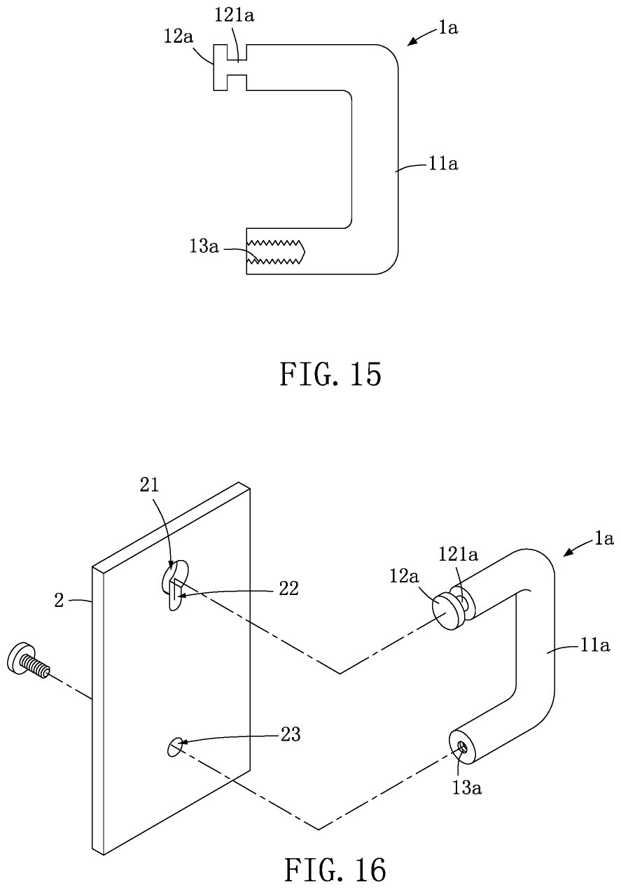

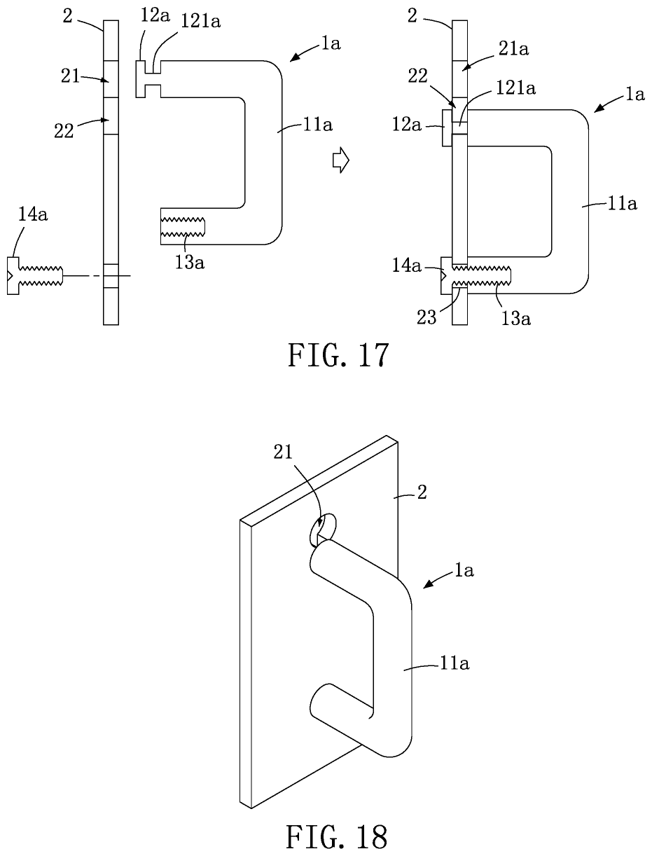

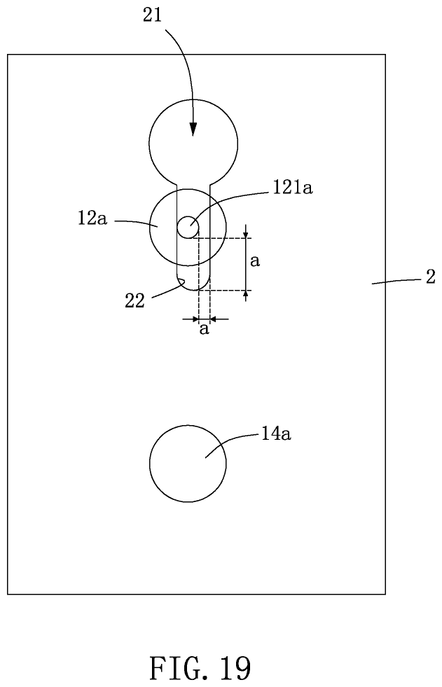

Please refer to FIGS. 15 to 19. A floating fixing component 1a according to an eleventh embodiment of the present disclosure includes an application section 11a and a retaining section 12a. The application section 11a can be a fastener, a grip or a handle; and the retaining section 12a is provided on an end of the application section 11a. The retaining section 12a includes a neck portion 121a for fastening to, coupling with or holding on a target object 2. The retaining section 12a and the target object 2 have a floating space “a” existed between them; such that the floating fixing component 1a is allowed to float and shift on and relative to the target object 2. In this embodiment, the floating space “a” is existed between the neck portion 121a of the floating fixing component 1a and the target object 2, so that the neck portion 121a of the floating fixing component 1a can float and shift on and relative to the target object 2.

To use the floating fixing component 1a, simply mount the retaining section 12a of the floating fixing component 1a to the target object 2. On the other hand, in the case it is not necessary to use the floating fixing component 1a, simply remove the retaining section 12a of the floating fixing component 1a from the target object 2. In this manner, the connection of the floating fixing component 1a to the target object 2 provides easy operation thereof and the removal of the floating fixing component from the target object 2 avoids collision of the floating fixing component with other objects (not shown).

According to the eleventh embodiment of the present disclosure, the application section 11a is provided on another end with a fixed connection portion 13a. The target object 2 is provided with an expanded receiving area 21 and a narrowed holding area 22 that are communicable with one another. To mount the floating fixing component 1a to the target object 2, first extend the retaining section 12a of the floating fixing component 1a through the expanded receiving area 21 of the target object 2. Then, move the neck portion 121a of the retaining section 12a into the narrowed holding area 22 of the target object 2. Due to the floating space “a”, the neck portion 121a can float and shift in and relative to the narrowed holding area 22 of the target object 2 to allow adjustment of the floating fixing component 1a to a suitable mounting position on and relative to the target object 2. After the neck portion 121a is moved into and held to the narrowed holding area 22, align the fixed connection portion 13a with a fixing area 23 formed on the target object 2 and fasten or thread a fastening element 14a to the fixed connection portion 13a on the other end of the application section 11a, such that the floating fixing component 1a is mounted to the target object 2 for use. To remove the floating fixing component 1a, simply release the fastening element 14a from the fixed connection portion 13a and move the neck portion 121a from the narrowed holding area 22 to the expanded receiving area 21. At this point, the retaining section 12a can be removed from the target object 2 to separate the floating fixing component 1a from the target object 2. In this manner, the floating fixing component 1a can be mounted to the target object 2 to provide easy operation or be dismounted from the target object 2 when necessary to avoid collision of the floating fixing component 1a with other objects (not shown).

In the eleventh embodiment of the present disclosure, the target object 2 can be a housing, a plate, a cabinet, a printed circuit board, a sheet, a metal body or a plastic body. In this manner, the present disclosure can meet more requirements in actual application thereof.

In the eleventh embodiment of the present disclosure, the narrowed holding area 22 can be a protrusion, a recess, or a stop structure for interfering with or abutting against the application section 11a, the retaining section 12a or the floating fixing component 1a. In this manner, the present disclosure can meet more requirements in actual application thereof.

In the eleventh embodiment of the present disclosure, the fixed connection portion 13a can be a threaded structure, a retaining structure, an elastic fastener, a hooking structure, a nut or a screw. In this manner, the present disclosure can meet more requirements in actual application thereof.

In the illustrated eleventh embodiment of the present disclosure, the fixed connection portion 13a is integrally formed with the floating fixing component 1a. In other operable embodiments, the fixed connection portion 13a can be bolted, riveted, fastened, expansion connected, welded, screwed, snapped or thermally sealed to the floating fixing component 1a. Alternatively, the fixed connection portion 13a can be integrated with the floating fixing component 1a through in-mold injection molding.

In the eleventh embodiment of the present disclosure, the floating fixing component 1a and all the parts thereof can be formed through lathing, forging, injection molding, in-mold injection molding, stamping, bending, movably connecting to one another, or assembling to one another. In this manner, the present disclosure can meet more requirements in actual application thereof.

In the eleventh embodiment of the present disclosure, the floating fixing component 1a and all the parts thereof can be made of a metal material, a non-metal material, or a plastic material. In this manner, the present disclosure can meet more requirements in actual application thereof.

In the eleventh embodiment of the present disclosure, the application section 11a, the retaining section 12a or the neck portion 121a of the floating fixing component 1a can be formed through in-mold plastic injection molding. In this manner, the present disclosure can meet more requirements in actual application thereof.

In the eleventh embodiment of the present disclosure, the retaining section 12a has a width smaller than that of the expanded receiving area 21; and the narrowed holding area 22 has a width larger than that of the neck portion 121a and smaller than that of the retaining section 12a. In this manner, the retaining section 12a can be first extended into the expanded receiving area 21a of the target object 2 and the neck portion 121a can be subsequently moved into the narrowed holding area 22 of the target object 2, such that the floating fixing component 1a is securely mounted to the target object 2.

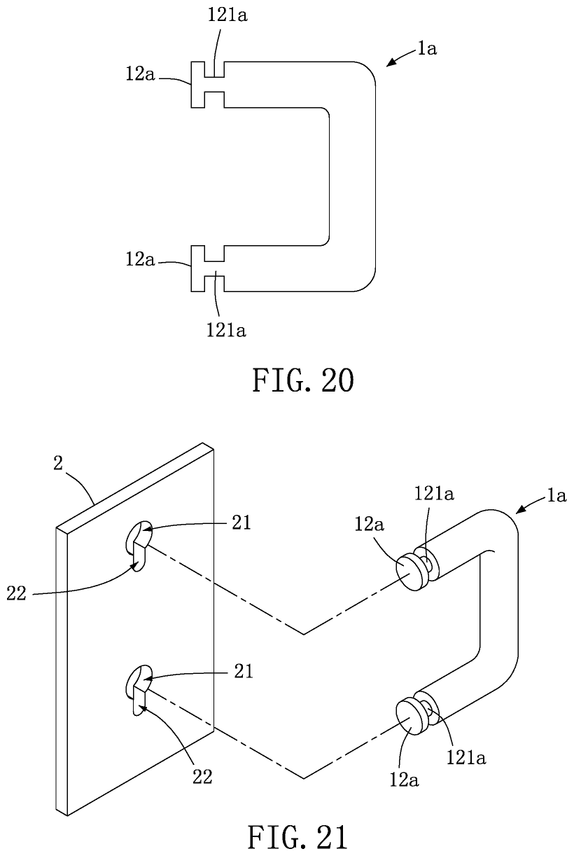

Please refer to FIGS. 20 and 21. A floating fixing component 1a according to a twelfth embodiment of the present disclosure is provided at two ends with a retaining section 12a each; and a target object 2 is correspondingly provided with two expanded receiving areas 21 and two narrowed holding areas 22. To use the floating fixing component 1a, first move the two retaining sections 12a into the two expanded receiving areas 21 of the target object 2. Then, move the neck portions 121a into the narrowed holding areas 22 of the target object 2. At this point, the floating fixing component 1a is mounted to the target object 2 for use. To dismount the floating fixing component 1a from the target object 2, simply move the neck portions 121a from the narrowed holding areas 22 into the expanded receiving areas 21 and then remove the retaining sections 12a from the target object 2. And, the floating fixing component 1a is separated from the target object 2. In this manner, the floating fixing component 1a can be mounted to the target object 2 for easy operation or be dismounted from the target object 2 when necessary to avoid collision of the floating fixing component 1a with the other objects (not shown).

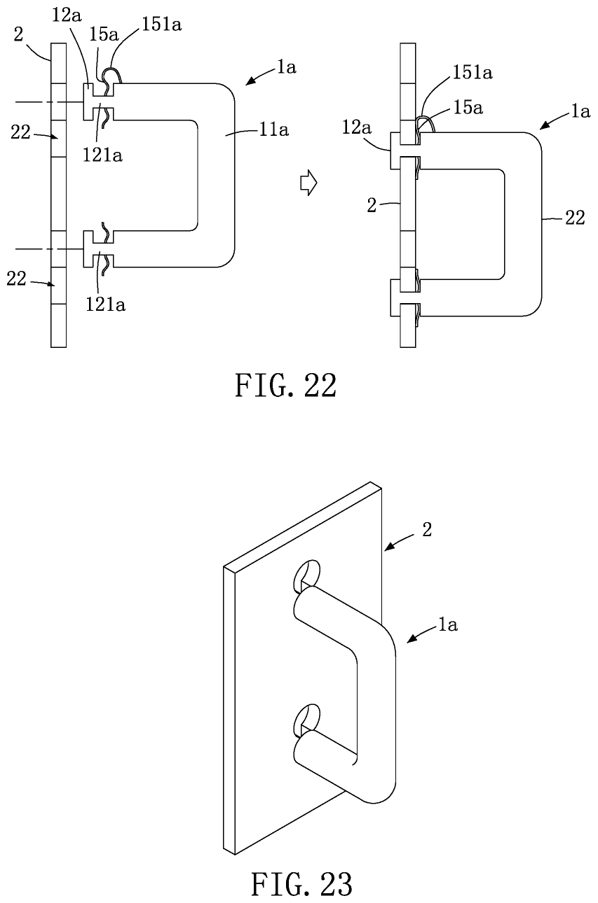

Please refer to FIGS. 22 and 23. In a thirteenth embodiment of the present disclosure, the floating fixing component 1a includes two retaining sections 12a. Each of the two retaining sections 12a includes a pressing element 15a fitted around the neck portion 121a for engaging with a narrowed holding area 22 formed on a target object 2. In the illustrated thirteenth embodiment, the retaining sections 12a and the abutting elements 15a are respectively two in number. However, it is understood there can be only one retaining section 12a and one abutting element 15a according to actual need in use. With the abutting element 15a, the floating fixing component 1a and the target object 2 can be securely connected to each other.

In the thirteenth embodiment of the present disclosure, the abutting element 15a can be a sheet spring, an elastic column, a spring or an elastic fastener, and the abutting elements 15a can be integrally formed with the floating fixing component 1a (not shown). In this manner, the present disclosure can meet more requirements in actual application thereof.

In the thirteenth embodiment of the present disclosure, each of the abutting elements 15a can be connected to the floating fixing component 1a via a connecting segment 151a. In this manner, the present disclosure can meet more requirements in actual application thereof.

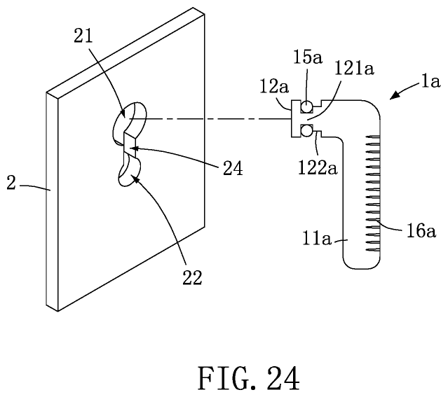

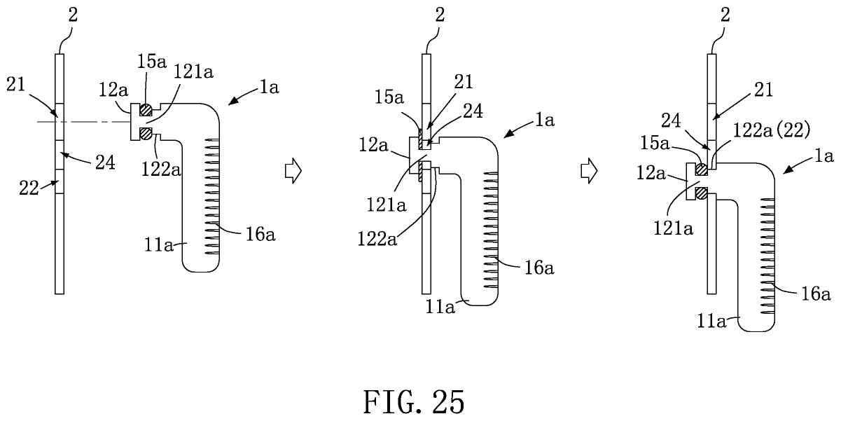

Please refer to FIGS. 24 and 25. In a fourteenth embodiment of the present disclosure, the floating fixing component 1a includes one retaining section 12a having an abutting element 15a and a clamped portion 122a. The target object 2 includes an expanded receiving area 21, a narrowed holding area 22 and an intermediate area 24, which are communicable with one another. The intermediate area 24 is located between the expanded receiving area 21 and the narrowed holding area 22. To mount the floating fixing component 1a to the target object 2, first move the retaining section 12a into the expanded receiving area 21 and then move the neck portion 121 into the intermediate area 24, and lastly, move the clamped portion 122a of the retaining section 12a into the narrowed holding area 22. At this point, the abutting element 15a is fastened to or located behind the narrowed holding area 22 to press against the retaining section 12a and the target object 2. In this manner, the floating fixing component 1a can be securely mounted to the target object 2.

In the fourteenth embodiment of the present disclosure, the floating fixing component 1a includes an anti-slip section 16a to provide a slip-prevention effect. The anti-slip section 16a can be a protrusion, a recess, an anti-slip structure, a planar surface, a toothed surface, a stepped surface, a curved surface, a cambered surface, or a beveled surface. In this manner, the present disclosure can meet more requirements in actual application thereof.

In the fourteenth embodiment of the present disclosure, the intermediate area 24 can be a protrusion, a recess or a stop structure for interfering with or abutting against the application section 11a, the retaining section 12a, the clamped portion 122a or the floating fixing component 1a. In this manner, the present disclosure can meet more requirements in actual application thereof.

In the fourteenth embodiment of the present disclosure, the retaining section 12a has a width smaller than that of the expanded receiving area 21, and the narrowed holding area 22 or the intermediate area 24 has a width larger than that of the neck portion 121a or the clamped portion 122a but smaller than that of the retaining section 12a. In this manner, the retaining section 12a can be first extended into the expanded receiving area 21 and the neck portion 121a can be then moved into the intermediate area 24, and lastly the clamped portion 122a of the retaining section 12a can be clamped to the narrowed holding area 22, such that the floating fixing component 1a is securely mounted to the target object 2.

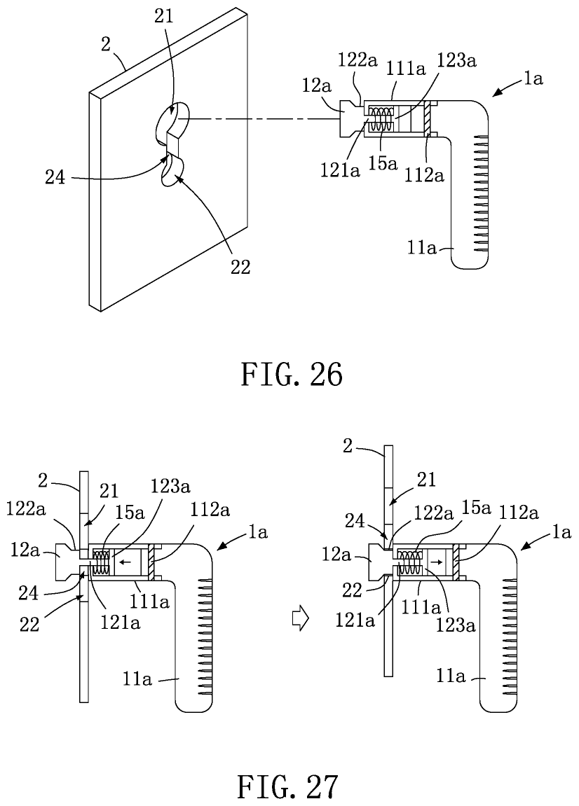

Please refer to FIGS. 26 and 27. In the floating fixing component 1a according to a fifteenth embodiment of the present disclosure, the neck portion 121a has a stop portion 123a, which is located in the application section 11a with a pressing element 15a provided between the application section 11a and the stop portion 123a. The pressing element 15a has an end pressed against the application section 11a and another end pressed against the stop portion 123a, such that the neck portion 121a is normally located at a retracted position relative to the application section 11a. To mount the floating fixing component 1a to the target object 2, apply an external force to the retaining section 12 to pull out the neck portion 121a from the retracted position and move the extended neck portion 121a into the intermediate area 24, and lastly, set the clamped portion 122a in the narrowed holding area 22. In this manner, the floating fixing component 1a can be securely mounted to the target object 2.

In the fifteenth embodiment of the present disclosure, the application section 11a includes a seat portion 111a, which is coupled or connected to the retaining section 12a and the neck portion 121a. The stop portion 123a is disposed in the seat portion 111a. The seat portion 111a is assembled to or movably connected to the application section 11a, or is held in the application section 11a via a connecting element 112a. In the illustrated fifteenth embodiment, the seat portion 111a is held in the application section 11a via the connecting element 112a, such that the seat portion 111a and the application section 11a are securely connected to each other.

In the fifteenth embodiment of the present disclosure, the connecting element 112a can be a shaft, a fastener, a rivet or a pin. In this manner, the present disclosure can meet more requirements in actual application thereof.

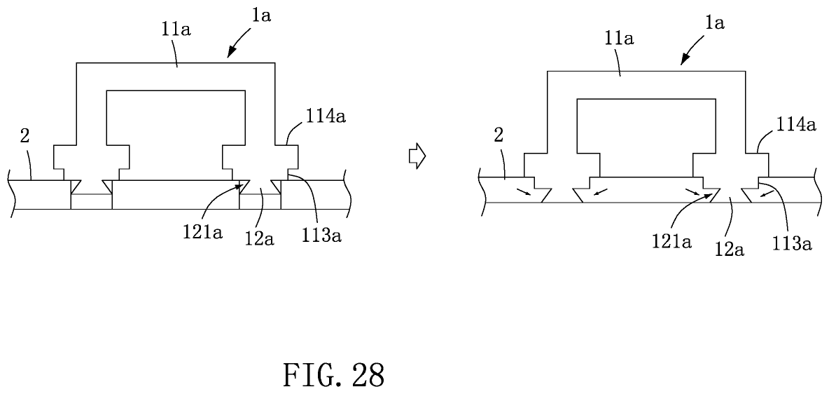

Please refer to FIG. 28. A floating fixing component 1a according to a sixteenth embodiment of the present disclosure includes a retaining section 12a having a neck portion 121a, which provides a material storage space, and an application section 11a having a material forcing portion 113a. When an external force is applied to push the application section 11a or to the retaining section 12a against a target object 2, a partial material of the target object 2 is forced or flows into the material storage space provided by the neck portion 121a and into the material forcing portion 113a of the application section 11a, such that the floating fixing component 1a is mounted to the target object 2.

In the sixteenth embodiment of the present disclosure, the external force can be further applied to a shoulder portion 114a formed on the application section 11a to facilitate the application of the external force to the application section 11a.

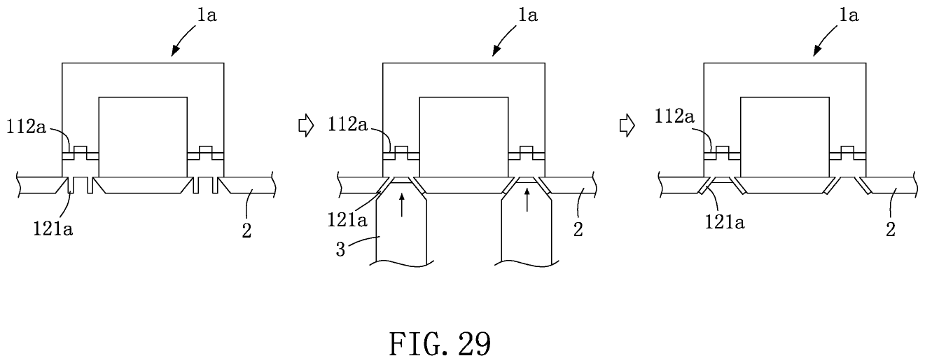

Please refer to FIG. 29. In a seventeenth embodiment of the present disclosure, a tool 3 is used to apply an external force to the retaining section 12a of the floating fixing component 1a, such that a neck portion 121a is formed at the retaining section 12a. The neck portion 121a provides a material retaining space for retaining a partial material of the target object 2 thereto, such that the floating fixing component 1a is mounted to the target object 2.

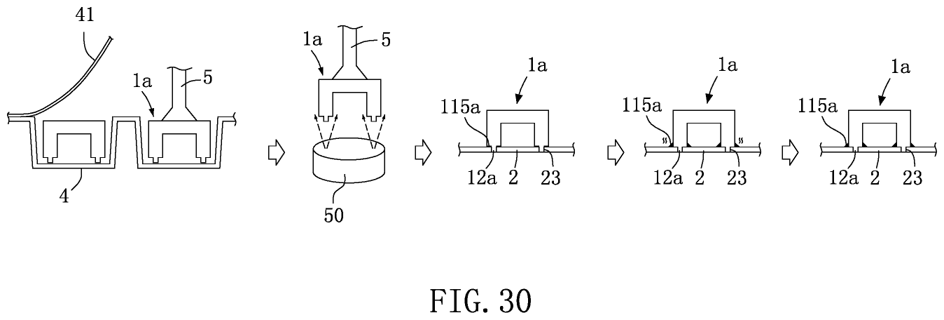

Please refer to FIG. 30. According to an eighteenth embodiment of the present disclosure, a plurality of floating fixing components 1a can be separately disposed in a carrier 4, which has or has not a cover 41. Each of the floating fixing components 1a can be picked up from the carrier 4 using a tool 5 and then be precisely put down on a target object 2 at a desired mounting position. The mounting position is determined by comparing the floating fixing component 1a with the target object 2 using a comparison device 50, such that the floating fixing component 1a can be correctly mounted to the target object 2.

In the eighteenth embodiment of the present disclosure, the floating fixing component 1a has an application section 11a and retaining sections 12a in the form of a neck structure each. The application section 11a or the neck structures of the retaining sections 12a have a weldable surface 115a for welding to corresponding fixing areas 23 on the target object 2, such that the floating fixing component 1a is securely mounted to the target object 2.

In the eighteenth embodiment of the present disclosure, the application section 11a or the retaining sections 12a are welded to the fixing areas 23 of the target object 2 at the weldable surface 115a using tin solder. The fixing areas 23 can be respectively an opening, an open slot, a planar surface, a recess or a protrusion corresponding to the weldable surface 115a. In this manner, the floating fixing component 1a can meet more requirements in actual application thereof.

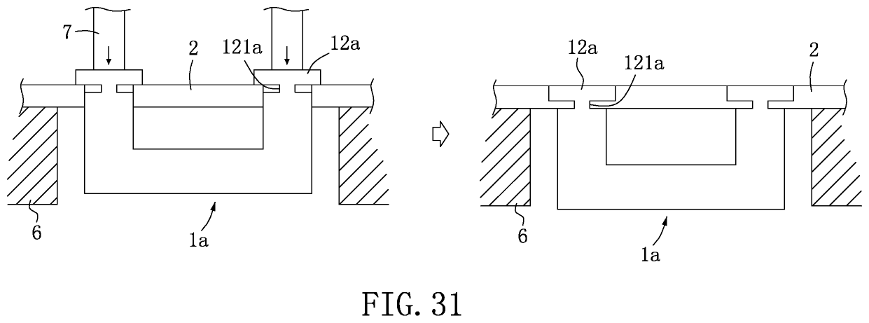

Please refer to FIG. 31. In a nineteenth embodiment of the present disclosure, the floating fixing component 1a includes an application section 11a and retaining sections 12a respectively having a neck portion 121a, which provides a material storage space. To mount the floating fixing component 1a to a target object 2, first position the target object 2 on a support mold 6 and then use a downward pressing mold 7 to apply a force to the retaining sections 12a or the application section 11a, such that a partial material of the target object 2 is forced or flows into the material storage space provided by the neck portion 121a, such that the floating fixing component 1a is mounted to the target object 2.

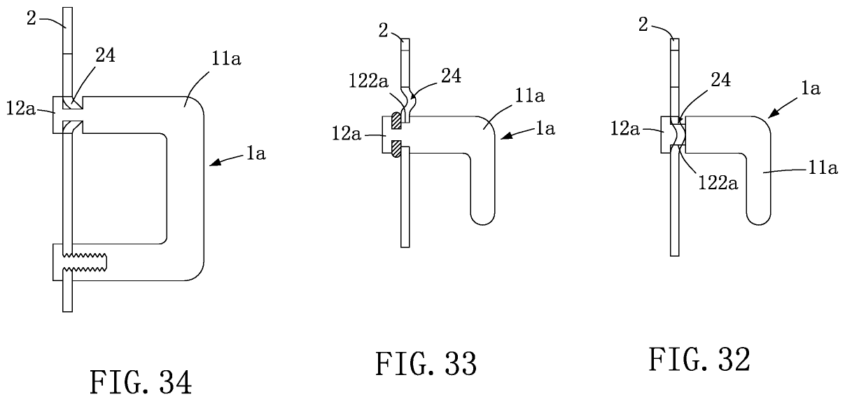

Please refer to FIGS. 32 to 34, which respectively show a twentieth, a twenty-first and a twenty-second embodiment of the present disclosure and the manner of mounting these floating fixing components 1a to a target object 2. In these embodiments, the target object 2 has an intermediate area 24 serving as a stop structure for interfering with or abutting against the application section 11a (see FIG. 34), the retaining section 12a (see FIG. 33), the clamped portion 122a (see FIG. 32), or the floating fixing component 1a. In this manner, the floating fixing component 1a of the present disclosure can meet more requirements in actual application thereof.

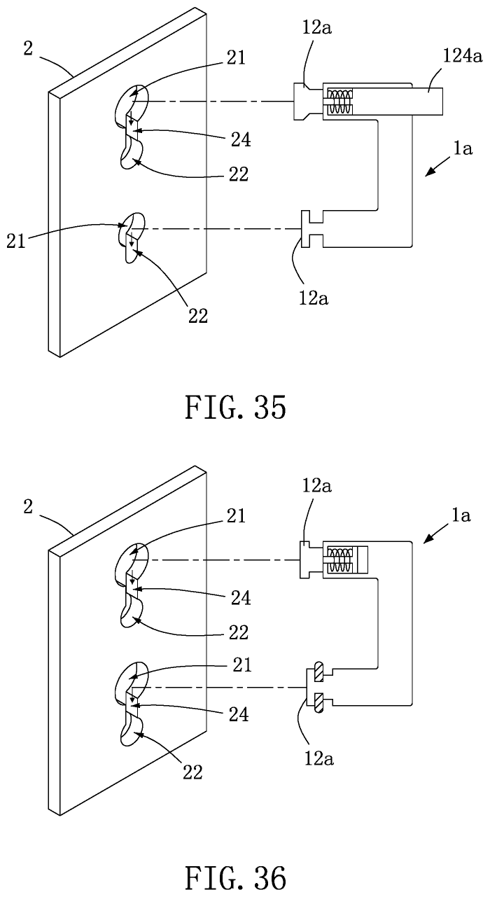

Please refer to FIG. 35. In a twenty-third embodiment of the present disclosure, the floating fixing component 1a includes two differently configured retaining sections 12a, 12a. One of the two retaining sections 12a includes a neck portion 121a, which has an operating section 124a rearward extended beyond the floating fixing component 1a for operating the retaining section 12a to move. In this case, the retaining section 12a is first moved into an expanded receiving area 21 of a target object 2 and then moved into an intermediate area 24 of the target object 2, and lastly, moved into a narrowed holding area 22 of the target object 2 to thereby connect to the target object 2. Meanwhile, the other retaining section 12a is sequentially moved into another expanded receiving area 21 and another narrowed holding area 22 formed on the target object 2, such that the floating fixing component 1a is securely mounted to the target object 2.

Please refer to FIG. 36, in which a first variant of the twenty-third embodiment is shown. In the first variant, the floating fixing component 1a includes two differently configured retaining sections 12a for simultaneously moving into two expanded receiving areas 21, two intermediate areas 24 and two narrowed holding areas 22 formed on the target object 2, such that the floating fixing component 1a is securely mounted to the target object 2.

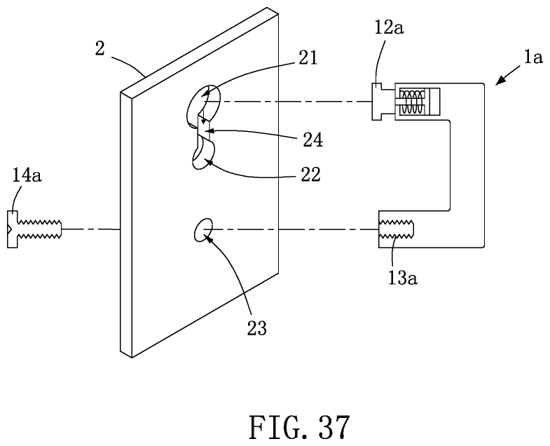

Please refer to FIG. 37, in which a second variant of the twenty-third embodiment is shown. In the second variant, the floating fixing component 1a includes a retaining section 12a and a fixed connection portion 13a. The retaining section 12a is sequentially moved into an expanded receiving area 21, an intermediate area 24 and a narrowed holding area 22 formed on the target object 2. The fixed connection portion 13a is aligned with a fixing area 23 formed on the target object 2 and is then fixedly locked thereto with a fastening element 14a. In this manner, the floating fixing component 1a can be securely mounted to the target object 2.

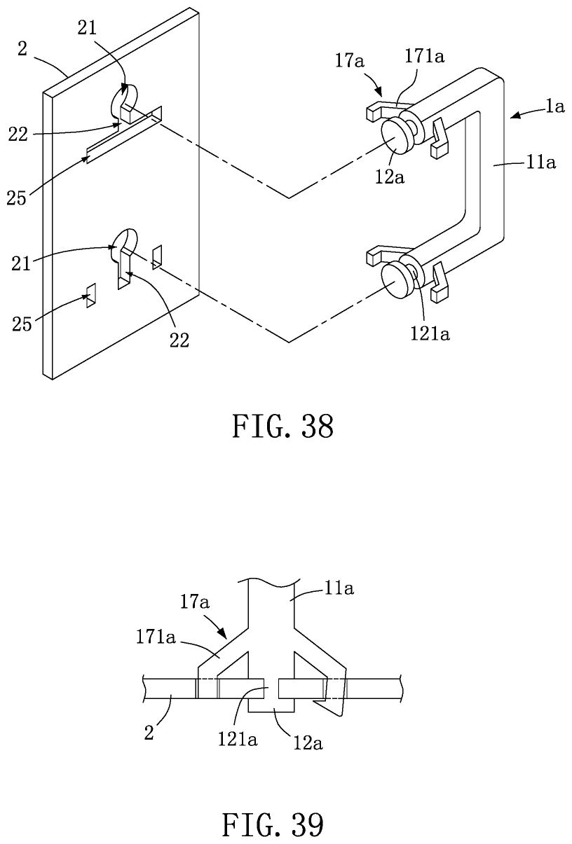

Please refer to FIGS. 38 and 39. In a twenty-fourth embodiment of the present disclosure, the floating fixing component 1a includes an application section 11a, at least one retaining section 12a and at least one fastening section 17a. To mount the floating fixing component 1a to a target object 2, first move the at least one retaining section 12a into at least one expanded receiving area 21 of the target object 2 and then move the at least one fastening section 17a into at least one locating area 25 of the target object 2, such that the at least one retaining section 12 is restricted from moving laterally, vertically or rotationally relative to the target object 2, or the at least one fastening section 17a is abutted against or interfered with a surface of the target object 2 and accordingly, the at least one retaining section 12a is restricted from moving laterally, vertically or rotationally relative to the target object 2. In this manner, the floating fixing component 1a can be securely mounted to the target object 2.

In the illustrated twenty-fourth embodiment of the present disclosure, there are shown four fastening sections 17a and two retaining sections 12a each having two fastening sections 17a provided at two opposite sides thereof. The number of the locating areas 25 is the same as that of the fastening sections 17a. In this manner, the floating fixing component 1a can be securely mounted to the target object 2.

In the twenty-fourth embodiment of the present disclosure, the fastening sections 17a are respectively an elastic fastener having an elastic fastening arm 171a. In this manner, the fastening sections 17a can be tightly held at the elastic fastening arms 171a to the locating areas 25, so that the floating fixing component 1a can be securely mounted to the target object 5.

In the twenty-fourth embodiment of the present disclosure, the locating areas 25 can be configured to be communicable with the narrowed holding areas 22. Alternatively, the locating areas 25 are independent of the narrowed holding areas 22. In this manner, the floating fixing component 1a of the present disclosure can meet more requirements in actual application thereof.

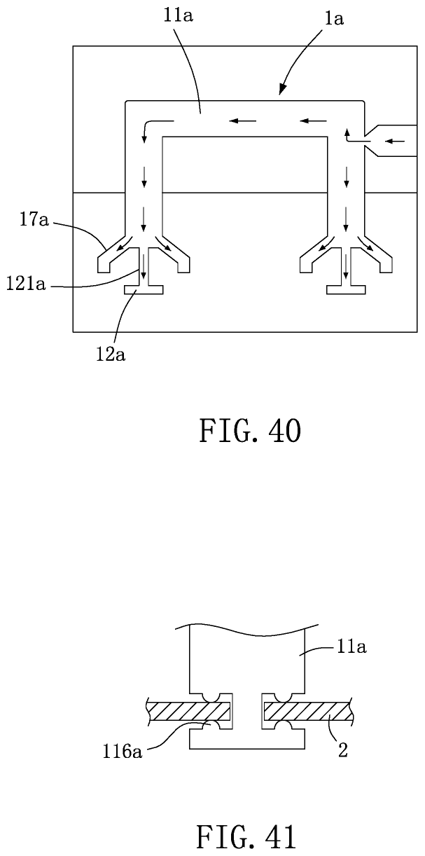

Please refer to FIG. 40. In a twenty-fifth embodiment of the present disclosure, the application section 11a, the retaining sections 12a, the neck portions 121a or the fastening sections 17a of the floating fixing component 1a are formed through in-mold plastic injection molding. In this manner, the present disclosure can meet more requirements in actual application thereof.

Please refer to FIG. 41. In a floating fixing component 1a according to a twenty-sixth embodiment, the application section 11a or the retaining section 12a is provided with an interfering portion 116a for interfering with or abutting against the target object 2. In this manner, the floating fixing component 1a can be securely mounted to the target object 2.

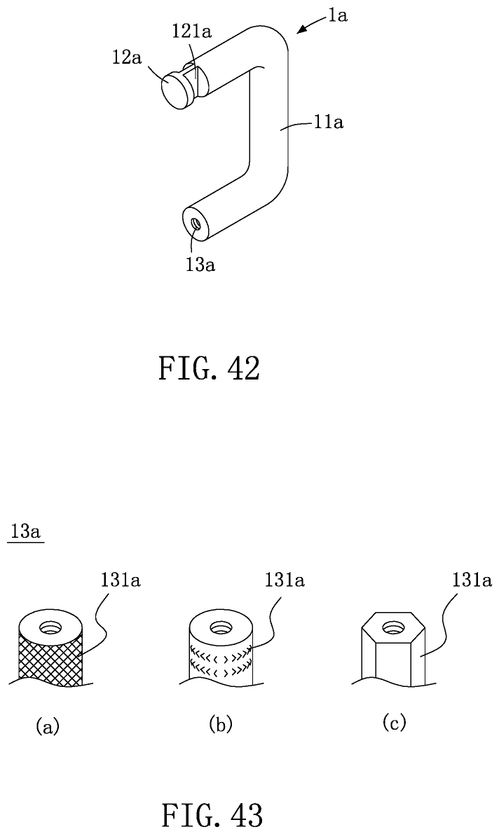

Please refer to FIG. 42. In a floating fixing component 1a according to a twenty-seventh embodiment of the present disclosure, the retaining section 12a is located at an end of the application section 11a and has a flat neck portion 121a for fastening to, mounting to or engaging with a target object 2. The neck portion 121a can be formed by cutting two slots at two opposite sides or cutting a slot at one single side of the retaining section 12a, or can be a column having a size smaller than that of the application section 11a or the retaining section 12a. In this manner, the present disclosure can meet more requirements in actual application thereof.

Please refer to FIG. 43. In the twenty-seventh embodiment, the floating fixing component 1a is provided with a fixed connection portion 13a, which has an anti-rotation section 131a formed on an outer surface thereof to prevent the fixed connection portion 13a provided on the application section 11a from separating from or rotating relative to a target object (not shown in FIG. 43). The anti-rotation section 131a can be an embossed pattern as shown in FIG. 43(a), a toothed pattern as shown in FIG. 43(b), a polygonal configuration as shown in FIG. 43(c), or a protrusion, a recess, a planar surface, a curved surface, a cambered surface, a tangential surface, a slot or a hole (not shown). In this manner, the present disclosure can meet more requirements in actual application thereof.

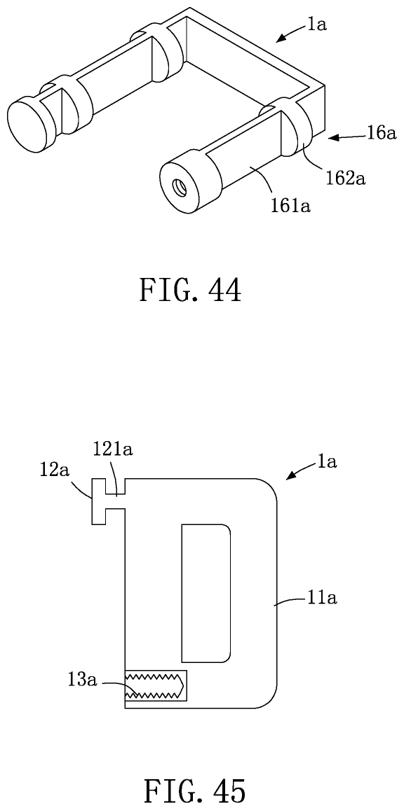

Please refer to FIG. 44. A floating fixing component 1a according to a twenty-eighth embodiment includes anti-slip sections 16a, which can be respectively a recess 161a or a protrusion 162a for preventing shrinkage or recession from occurring on the surface of the floating fixing component 1a when the latter is formed through in-mold plastic injection molding.

In the twenty-eighth embodiment of the present disclosure, the application section 11a or the retaining section 12a is provided with an electroplated layer, which can be a zinc coating, a nickel coating, a tin coating, a chrome coating, an anodized coating, or a copper coating. To perform the electroplating process, the application section 11a or the retaining section 12a is put in an electrically conductive solution. The material to be coated on the application section 11a or the retaining section 12a is transferred from the electrically conductive solution to the application section 11a or the retaining section 12a and is attached thereto. The application section 11a, the retaining section 12a, the electrically conductive solution, or the material for forming the coating is conductive when an electric current is applied thereto, such that the material for forming the coating can be transferred to attach to the application section 11a or the retaining section 12a. In this way, the electroplated layer serves as a protection to the application section 11a or the retaining section 12a and advantageously extends the service life of the application section 11a or the retaining section 12a.

Further, the application section 11a or the retaining section 12a can be made of a metal material, a non-metal material, or a plastic material; and the application section 11a or the retaining section 12a can be covered by a baking paint layer, a colored plastic cover, or a plastic layer (not shown), which serves as a protection to the application section 11a or the retaining section 12a and advantageously extends the service life of the application section 11a or the retaining section 12a, allowing the floating fixing component 1a to meet different requirements in actual application thereof.

In the twenty-eighth embodiment of the present disclosure, the application section 11a or the retaining section 12a can be otherwise provided on an outer surface with a layer of anti-corrosion substance. For this purpose, the application section 11a or the retaining section 12a is put in an electrically conductive solution, and the anti-corrosion substance is transferred by the electrically conductive solution to the application section 11a or the retaining section 12a and is attached thereto. The application section 11a, the retaining section 12a, the electrically conductive solution, or the anti-corrosion substance is conductive when an electric current is applied thereto, such that the anti-corrosion substance can be transferred to attach to the application section 11a or the retaining section 12a. In this way, the anti-corrosion substance serves as a protection to the application section 11a or the retaining section 12a and advantageously extends the service life of the application section 11a or the retaining section 12a.

Please refer to FIG. 45. In a twenty-ninth embodiment of the present disclosure, the floating fixing component 1a has an application section 11a that is substantially D-shaped with a retaining section 12a and a fixed connection portion 13a located at the same side of the application section 11a. In this configuration, the floating fixing component 1a of the present disclosure can meet more requirements in actual application thereof.

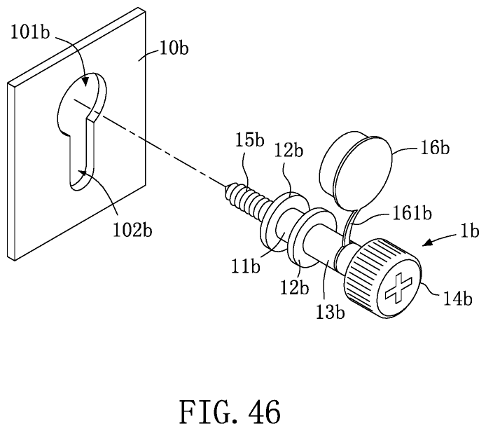

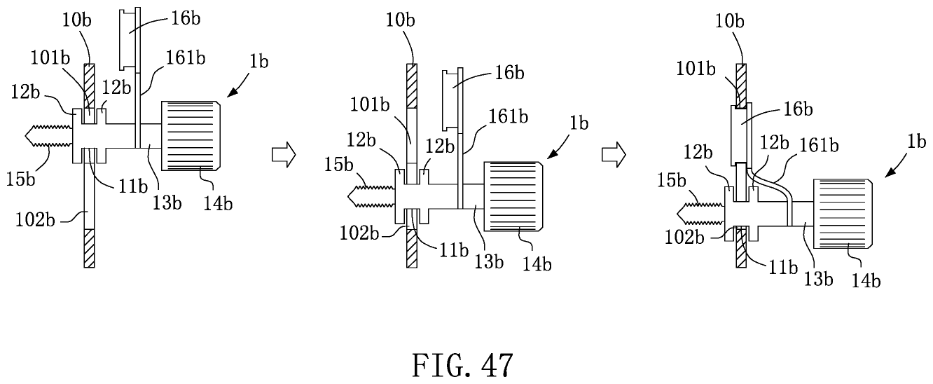

Please refer to FIGS. 46 and 47, which show a floating fixing component 1b according to a thirtieth embodiment of the present disclosure and the manner of mounting the same to a first object 10b. As shown, the floating fixing component 1b includes a retaining section 11b and two stop sections 12b, such that the floating fixing component 1b can be fastened at the retaining section 11b and the stop sections 12b to the first object 10b. The first object 10b is formed with an expanded receiving area 101b and a narrowed holding area 102b that are communicable with each other. To mount the floating fixing component 1b to the first object 10b, first extend the stop sections 12b through the expanded receiving area 101b and then move the retaining section 11b into the narrowed holding area 102b, such that the floating fixing component 1b is limited by the two stop sections 12b from moving relative to the first object 10b. The retaining section 11b has an outer diameter smaller than that of the narrowed holding area 102b, and the stop sections 12b respectively have an outer diameter larger than that of the narrowed holding area 102b. In this manner, the floating fixing component 1b can be mounted to the first object 10b while a second retaining section 15b of the floating fixing component 1b can be retained to or released from a second object (not shown). In this manner, at least two objects can be repeatedly and quickly connected to or disconnected from one another.

In the thirtieth embodiment of the present disclosure, the floating fixing component 1b further includes an application section 13b movably assembled at two opposite ends to a head portion 14b and the second retaining section 15b. After the floating fixing component 1b is mounted to the first object 10b, the head portion 14b can be driven to connect or release the second retaining section 15b to or from the second object (not shown). In this manner, at least two objects can be repeatedly and quickly connected to or disconnected from one another.

In the thirtieth embodiment of the present disclosure, the second retaining section 15b can be a threaded structure, a male fastener, a female fastener, an I-shaped structure or a column. In this manner, the second retaining section 15b can meet more requirements for connecting to the second object.

In the thirtieth embodiment of the present disclosure, the floating fixing component 1b further includes a stop member 16b, which can be set in or abutted against the expanded receiving area 101b or the narrowed holding area 102b to cover the expanded receiving area 101b or the narrowed holding area 102b, such that the retaining section 11b is stopped from separating from the expanded receiving area 101b or the narrowed holding area 102b. This in turn allows the floating fixing component 1b to be securely mounted to the first object 10b.

In the thirtieth embodiment of the present disclosure, the stop member 16b includes a connecting section 161b, which is connected to the application section 13b of the floating fixing component 1b or is integrally formed with the floating fixing component 1b. With the connecting section 161b, a lost stop member 16b can be prevented.

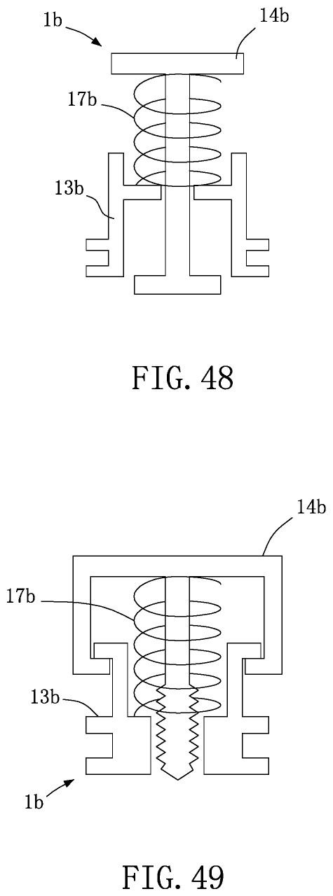

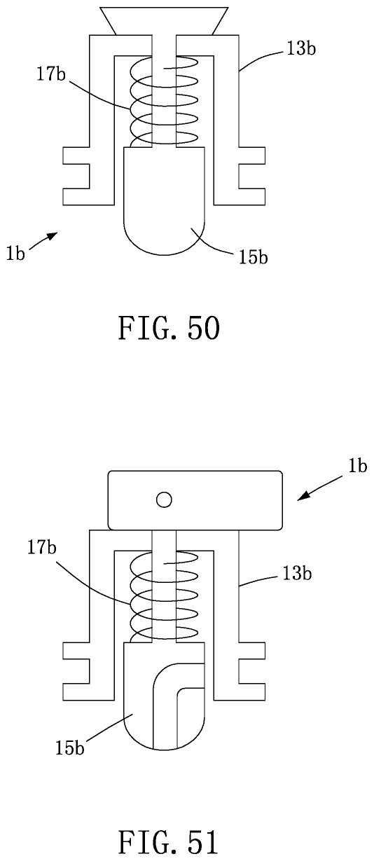

Please refer to FIGS. 48 to 51, in which a thirty-first, a thirty-second, a thirty-third and a thirty-fourth embodiment of the present disclosure are respectively shown. In the thirty-first and the thirty-second embodiment shown in FIGS. 48 and 49, the head portion 14b and the application section 13b have an elastic element 17b disposed between them to elastically stop them from moving. In the thirty-third and the thirty-fourth embodiment shown in FIGS. 50 and 51, the second retaining section 15b and the application section 13b have an elastic element 17b disposed between them to elastically stop them from moving. In this manner, the floating fixing component 1b can meet more requirements in actual application thereof.

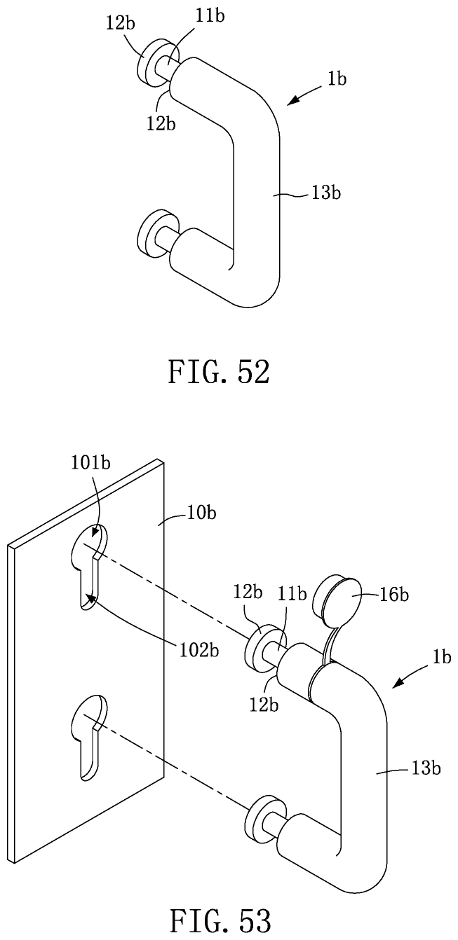

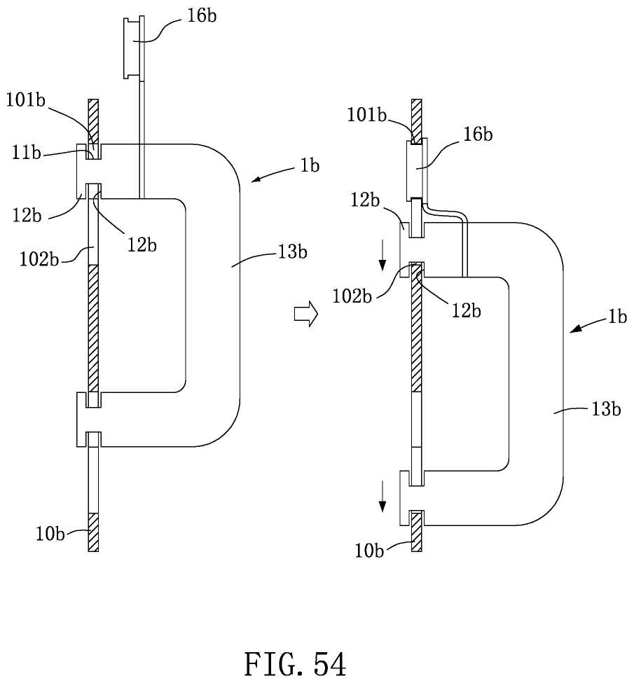

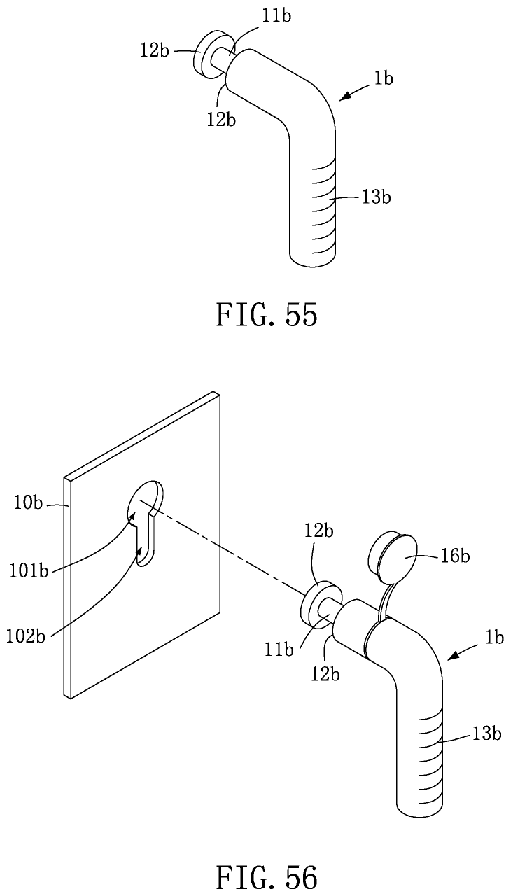

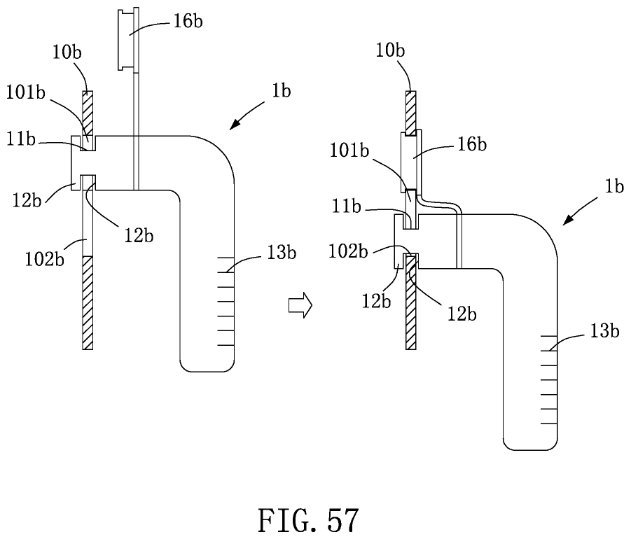

Please refer to FIGS. 52 to 57. In a thirty-fifth embodiment of the present disclosure, the floating fixing component 1b includes an application section 13b, which is a floating member, and more particularly a floating member with a retaining section 11b and a stop section 12b separately provided on two ends thereof (see FIGS. 52 and 53). However, in a thirty-sixth embodiment of the present disclosure as shown in FIGS. 55 to 57, the application section 13b is a floating member having a retaining section 11b and a stop section 12b provided on only one end thereof. To mount the floating fixing component 1b to a first object 10b, first extend the stop sections/section 12b through corresponding expanded receiving areas/area 101b of the first object 10b and then move the retaining sections/section 11b into corresponding narrowed holding areas/area 102b of the first object 10b, such that the stop sections/section 12b are/is located behind the first object 10 to limit the floating fixing component 1b from moving. Lastly, set or press a stop member 16b in or against one expanded receiving area 101b to prevent the retaining section 11b from separating from that expanded receiving area 101b. In this manner, the floating fixing component 1b can be securely mounted to the first object 10b.

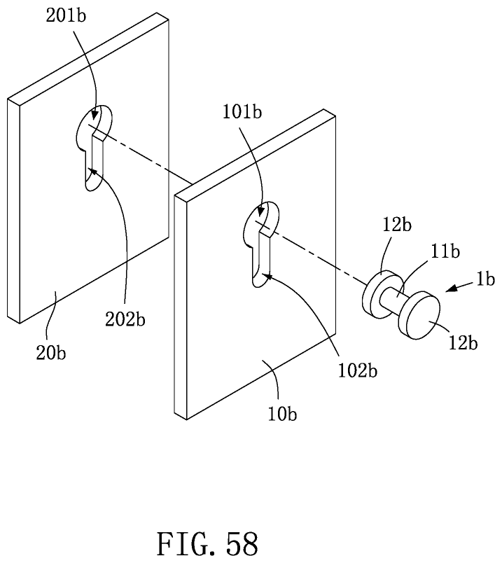

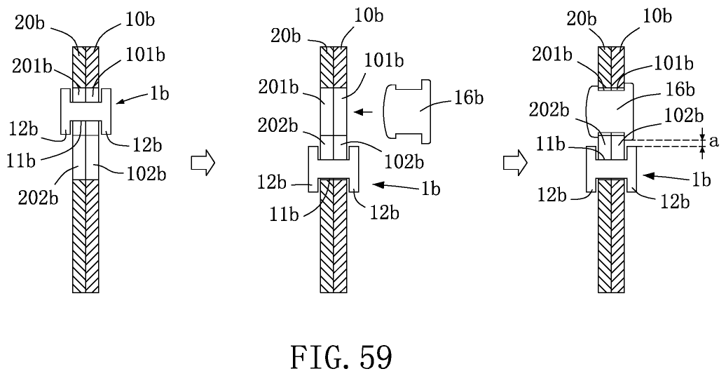

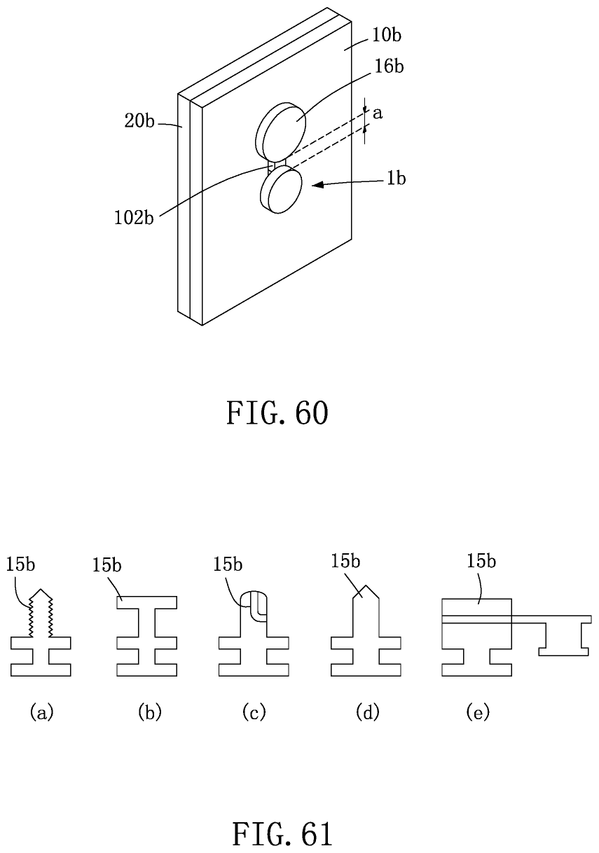

Please refer to FIGS. 58 to 60. In the floating fixing component 1b according to a thirty-seventh embodiment of the present disclosure, the stop section 12b can be extended through the expanded receiving area 101b of the first object 10b and an expanded receiving area 201b of a second object 20b, and the retaining section 11b can be moved into the narrowed holding area 102b of the first object 10b and a narrowed holding area 202b of the second object 20b, and finally, the stop member 16b can be set in or pressed against the expanded receiving areas 101b, 201b to prevent the retaining section 11b from moving out of the expanded receiving areas 101b, 201b. In this manner, the floating fixing component 1b can be used to securely connect the first and the second object 10b, 20b to each other.

In the thirty-seventh embodiment of the present disclosure, portions of the expanded receiving area 101b and the expanded receiving area 201b located between the stop section 12b and the stop member 16b forms a floating space “a”, or portions of the narrowed holding area 102b and the narrowed holding area 202b located between the retaining section 11b and the stop member 16b forms a floating space “a”, so that the stop section 12b or the retaining section 11b is allowed to move in the floating space “a”. The floating space “a” has a size ranged between 0.01 mm and 50000 mm, and defines a movement track of the floating fixing component. In this manner, the floating fixing component of the present disclosure can meet more requirements in actual application thereof.

Please refer to FIG. 61. In the thirtieth embodiment of the present disclosure, the floating fixing component 1b can have a second retaining section 15b to be differently configured as a threaded member as shown in FIG. 61(a), a male fastening member as shown in FIG. 61(b), a female fastening member as shown in FIG. 61(c), a column as shown in FIG. 61(d), or a head portion as shown in FIG. 61(e), or a female threaded member, a male threaded member, a slot or a hole (not shown).

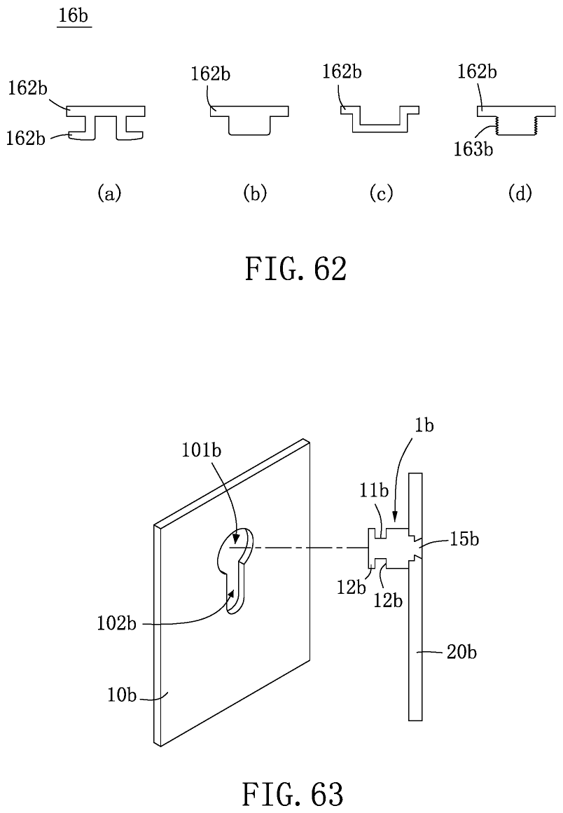

Please refer to FIG. 62. In a preferred embodiment of the present disclosure, the stop member 16b can be differently configured as a fastener or an elastic fastener as shown in FIG. 62(a), a plug as shown in FIG. 62(b), a plate as shown in FIG. 62(c), a threaded member as shown in FIG. 62(d), or a sheet spring (not shown). The stop member 16b can be made of a metal material, a nonmetal material, a plastic material, a rubber material or a silicone material. The stop member 16b may be configured to include a flange portion 162b as that shown in FIGS. 62(a), (b), (c) and (d). The flange portion 162b has a size larger than that of the expanded receiving area 101b or the narrowed holding area 102b of the first object 10b, such that the flange portion 162b can be retained or fastened to the expanded receiving area 101b, the narrowed holding area 102b or any area of the first object 10b. The stop member 16b can also include an application portion 163b as that shown in FIG. 62(d). The application portion 163b has a size larger than, equal to or smaller than that of the expanded receiving area 101b or the narrowed holding area 102b (not shown). In this manner, the stop member 16b can meet more requirements when being mounted to the first object 10b.

Please refer to FIG. 63. In a thirty-eighth embodiment of the present disclosure, the floating fixing component 1b includes a second retaining section 15b, which can be riveted, expansion connected, screwed, welded or fastened to a second object 20b; and two stop sections 12b, one of which is extended through an expanded receiving area 101b of a first object 10b, and a retaining section 11b for moving into a narrowed holding area 102b on the first object 10b, such that the floating fixing component 1b is restricted by the two stop sections 12b from moving relative to the first object 10b. In this manner, the floating fixing component 1b can be securely mounted to the first object 10b.

In the thirty-eighth embodiment of the present disclosure, the second retaining section 15b can be in the form of a material receiving slot. When the floating fixing component 1b applies an external force to the second object 20b, a partial material of the second object 20b is forced or flows into the material receiving slot provided by the second retaining section 15b, such that the floating fixing component 1b is securely connected to the second object 20b.

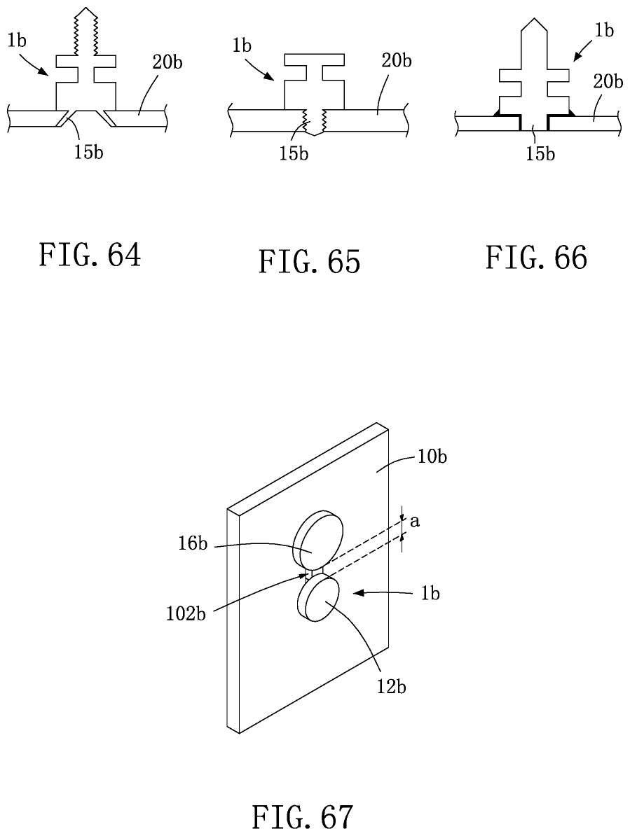

Please refer to FIGS. 64 to 66. In a thirty-ninth, a fortieth and a forty-first embodiment of the present disclosure, the second retaining section 15b of the floating fixing component 1b can be differently configured. In the thirty-ninth embodiment as shown in FIG. 64, the second retaining section 15b is an expansion connection section, which is deformed to engage with the second object 20b when an external force is applied to the second retaining section 15b, such that the floating fixing component 1b is securely connected to the second object 20b. In the fortieth embodiment as shown in FIG. 65, the second retaining section 15b is a threaded section for screwing into the second object 20b, such that the floating fixing component 1b is securely connected to the second object 20b. In the forty-first embodiment as shown in FIG. 66, the second retaining section 15b is a weldable section for welding to the second object 20b, such that the floating fixing component 1b is securely connected to the second object 20b.

Please refer to FIG. 67 that shows a forty-second embodiment of the present disclosure. In this embodiment, the floating fixing component 1b includes a stop section 12b that can be extended through an expanded receiving area 101b on a first object 10b, and a retaining section 11b that can be moved into a narrowed holding area 102b on the first object 10b; and a stop member 16b for setting in or pressing against the expanded receiving area 101b to prevent the retaining section 11b from moving out of the expanded receiving area 101b. A portion of the expanded receiving area 101b located between the stop section 12b and the stop member 16b or a portion of the narrowed holding area 102b located between the retaining section 11b and the stop member 16b forms a floating space “a”, such that the retaining section 11b or the stop section 12b is movable in the floating space “a”. In this manner, the floating fixing component 1b can be securely mounted to the first object 10b.

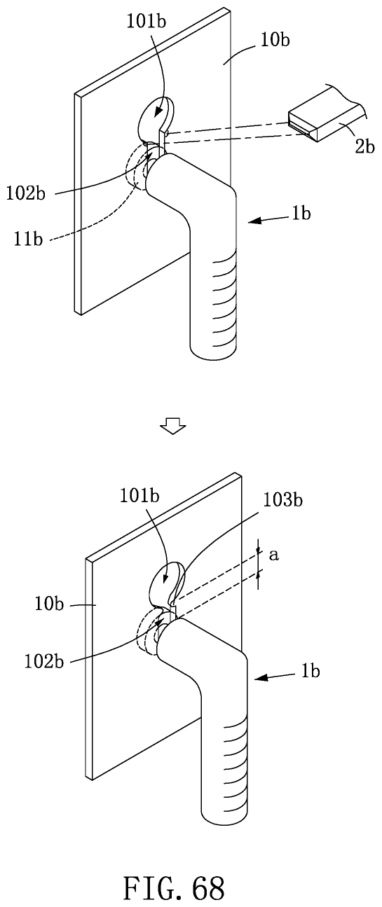

Please refer to FIG. 68 that shows a forty-third embodiment of the present disclosure and the manner of mounting it to a first object 10b. In this embodiment, the floating fixing component 1b includes a retaining section 11b to be set in a narrowed holding area 102b on the first object 10b. For this purpose, the retaining section 11b is first moved into the narrowed holding area 102b and then a tool 2 is used to apply an external force to an expanded receiving area 101b or the narrowed holding area 102b of the first object 10b to form a deformed area 103b on the expanded receiving area 101b or the narrowed holding area 102b to block the same, such that the deformed area 103b prevents the retaining section 11b from moving out of the expanded receiving area 101b or the narrowed holding area 102b.

In the forty-third embodiment of the present disclosure, a floating space “a” is existed between the deformed area 103b and the retaining section 11b or the stop section 12b, such that the retaining section 11b or the stop section 12b is movable in the floating space “a”. The floating space “a” has a size ranged between 0.01 mm and 50000 mm and defines a movement track of the floating fixing component 1b. In this manner, the present disclosure can meet more requirements in actual application thereof.

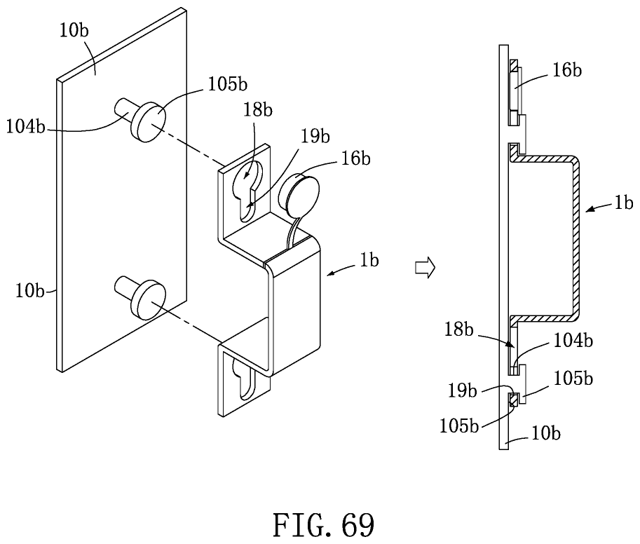

Please refer to FIG. 69 that shows a forty-fourth embodiment of the present disclosure and a mounting manner thereof. In this embodiment, the floating fixing component 1b includes two expanded receiving areas 18b and two narrowed holding areas 19b, and a first object 10b is correspondingly provided with two retaining sections 104b and two stop sections 105b. To mount the floating fixing component 1b to the first object 10b, first move the expanded receiving areas 18b through the stop sections 105b and then move the narrowed holding areas 19b to engage them with the retaining sections 104b, such that the two stop sections 105b restrict the floating fixing component 1b from moving relative to the first object 10b. In this manner, the present disclosure can meet more requirements in actual application thereof.

In the forty-fourth embodiment of the present disclosure, the floating fixing component 1b further includes a stop member 16b for stopping the floating fixing component 1b from moving laterally relative to the first object 10b and ensuring the floating fixing component 1b is held to the first object 10b without the risk of separating therefrom. In this manner, the floating fixing component 1b can be securely mounted to the first object 10b.

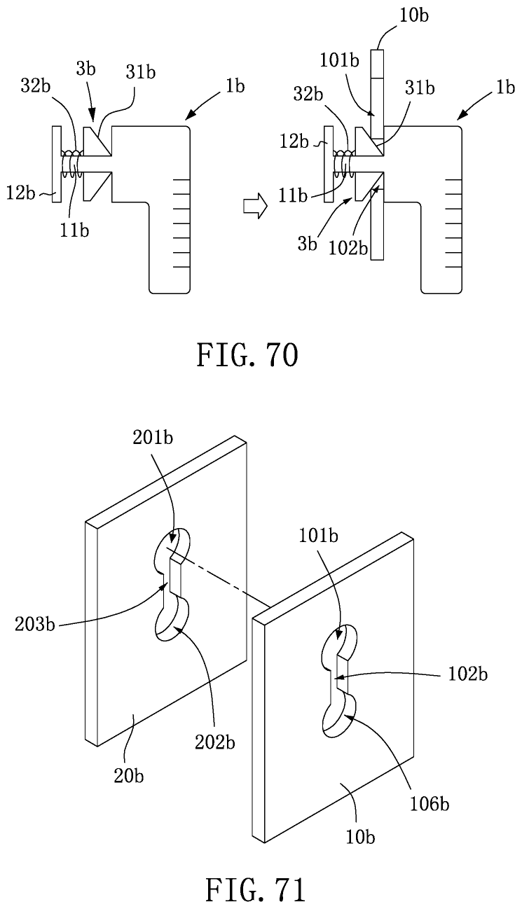

Please refer to FIG. 70, which shows a forty-fifth embodiment of the present disclosure and the mounting manner thereof. In the forty-fifth embodiment, the floating fixing component 1b includes a retaining section 11b having an abutting member 3b fitted therearound or coupled therewith. After the retaining section 11b and the abutting member 3b are extended through an expanded receiving area 101b and moved into a narrowed holding area 102b on a first object 10b, the abutting member 3b abuts against the narrowed holding area 102b. In this manner, the floating fixing component 1b can be securely mounted to the first object 10b while the retaining section 11b is restricted from moving out of the expanded receiving area 101b or the narrowed holding area 102b.

In the forty-fifth embodiment of the present disclosure, the abutting member 3b includes a guide portion 31b for guiding the abutting member 3b to engage with or abut against the narrowed holding area 102b. The guide portion 31b can be a slant surface, a curved surface, a cambered surface, a stepped surface or a planar surface. In this manner, the present disclosure can meet more requirements in actual application thereof.

In the forty-fifth embodiment of the present disclosure, the abutting member 31b further includes an elastic element 32b, which has an end pressed against the abutting member 3b and another end pressed against a stop section 12b of the floating fixing component 1b located at a front end of the retaining section 11b. In this manner, the floating fixing component 1b can be securely mounted to the first object 10b while the retaining section 11b is prevented from moving out of the expanded receiving area 101b or the narrowed holding area 102b.

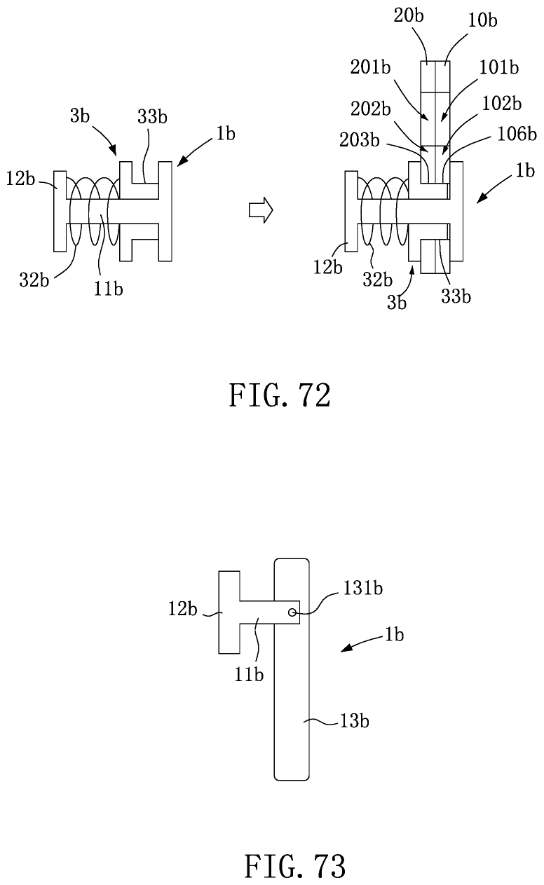

Please refer to FIG. 71 that shows a first object 10b and a second object 20b according to a forty-sixth embodiment of the present disclosure for using with a floating fixing component 1b, and to FIG. 72 that shows a floating fixing component 1b according to a forty-seventh embodiment of the present disclosure and the manner of mounting the same to the first and the second object 10b, 20b of FIG. 71. In the forty-seventh embodiment, the floating fixing component 1b includes a retaining section 11b having an abutting member 3b fitted therearound or coupled therewith. The abutting member 3b is used to abut against a clamping area 106b on the first object 10b and another clamping area 203b on the second object 20b. In this manner, the floating fixing component 1b can securely connect the first and the second object 10b, 20b to one another.

In the forty-seventh embodiment of the present disclosure, the abutting member 3b includes a stepped portion 33b, which can be engaged with the clamping areas 106b, 203b on the first and the second object 10b, 20b, respectively, to hold the abutting member 3b in place. The stepped portion 33b has a width larger than or smaller than that of the narrowed holding areas 102b, 202b on the first and the second object 10b, 20b, but the stepped portion 33b has a width smaller than that of the clamping areas 106b, 203b of the first and the second object 10b, 20b, such that the abutting member 3b can be held in place in the clamping areas 106b, 203b. In this manner, the present disclosure can meet more requirements in actual application thereof.

Please refer to FIG. 73, which shows a forty-eighth embodiment of the present disclosure. In this embodiment, the floating fixing component 1b has an application section 13b, which is bolt-connected to a retaining section 11b via a coupling element 131b. In this manner, the present disclosure can meet more requirements in actual application thereof.

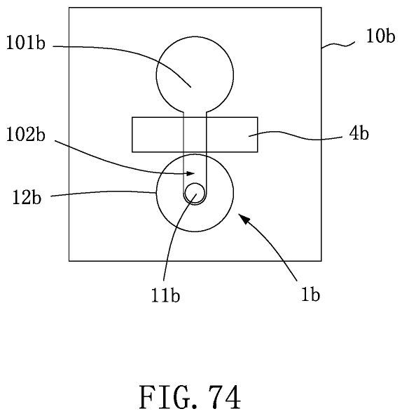

Please refer to FIG. 74, which shows a forty-ninth embodiment of the present disclosure. In the forty-ninth embodiment, the floating fixing component 1b further includes a blocking member 4b, which blocks an expanded receiving area 101b of a first object 10b or a retaining section 11b of the floating fixing component 1b to prevent the retaining section 11b from moving out of the expanded receiving area 101b or a narrowed holding area 102b of the first object 10b. In this manner, the present disclosure can meet more requirements in actual application thereof.

While the present disclosure has been described by means of specific embodiments, numerous modifications and variations could be made thereto by a person skilled in the art without departing from the scope and spirit of the present disclosure set forth in the claims.

What is claimed is:

1. A floating fixing component, comprising at least a stop section and an application section; the stop section being used to abut against an object to prevent the floating fixing component from separating from the object; and the floating fixing component and the object having a floating space existed between them, such that the floating fixing component can float and shift on and relative to the object.

2. The floating fixing component according to claim 1, further comprising an anti-rotation section corresponding to a matching anti-rotation section on the object, such that the anti-rotation section and the matching anti-rotation section are not rotatable relative to one another; and the floating space being existed between the anti-rotation section and the matching anti-rotation section, such that the floating fixing component can float and shift on and relative to the object.

3. The floating fixing component according to claim 1, further comprising at least one engaging section, which has a material storage space and a pressing section; the engaging section having rigidity higher than that of the stop section, and a partial material of the stop section being forced or flowing into the material storage space of the engaging section when a force is applied to the stop section, such that the stop section is engaged with the engaging section.

4. The floating fixing component according to claim 1, further comprising at least one engaging section, which provides a material storage space; a partial material of the stop section being forced or flowing into the material storage space of the engaging section when a force is applied to the engaging section, such that the stop section is engaged with the engaging section.

5. The floating fixing component according to claim 1, further comprising at least one engaging section; wherein a force can be applied to the engaging section, such the engaging section under pressure is expanded to form a material storage space for receiving a partial material of the stop section, bringing the stop section to engage with the engaging section.

6. The floating fixing component according to claim 1, further comprising at least one engaging section that provides a material storage space; and wherein the stop section is sideward engaged with the material storage space of the engaging section.

7. The floating fixing component according to claim 1, further comprising at least one engaging section that provides a material storage space; wherein the stop section is an elastic fastener having an open slot and can be pressed against the engaging section to expand the open slot and enter into the material storage space of the engaging section, such that the stop section is engaged with the engaging section.

8. The floating fixing component according to claim 1, further comprising at least one engaging section; and wherein a force can be applied to the engaging section, such that the engaging section is expanded and deformed to press against the object.

9. A floating fixing component, comprising at least a stop section and an application section; the stop section being used to press against an object to prevent the floating fixing component from separating from the object; and a floating space being existed between the stop section and the application section, such that the application section can float and shift on and relative to the stop section.

10. A method of mounting a floating fixing component to an object, the floating fixing component including an anti-rotation section and at least a stop section and an application section, comprising the following steps: aligning the anti-rotation section with a matching anti-rotation section provided on the object, such that the anti-rotation section and the matching anti-rotation section are not rotatable relative to one another, and abutting the stop section against the object to prevent the floating fixing component from separating from the object; wherein a floating space is existed between the anti-rotation section and the matching anti-rotation section after the floating fixing component has been mounted to the object, such that the floating fixing component can float and shift on and relative to the object.

11. A floating fixing component, comprising an application section and a retaining section; the retaining section being provided on an end of the application section and including a neck portion for fastening to, coupling with or holding on a target object; and a floating space being existed between the retaining section and the target object, such that the floating fixing component can float and shift relative to the target object.

12. The floating fixing component according to claim 11, wherein the retaining section is first extended through an expanded receiving area provided on the target object and then the neck portion of the retaining section is moved into a narrowed holding area provided on the target object.

13. The floating fixing component according to claim 12, wherein the application section includes a fixed connection portion formed on another end thereof; and a fastening element being fastened to or threaded into the fixed connection portion of the application section to connect the application section to the target object after the neck portion of the retaining section is moved into and held to the narrowed holding area of the target object.

14. The floating fixing component according to claim 11, wherein the retaining section further includes a clamped portion, and the target object includes an expanded receiving area, an intermediate area and a narrowed holding area; and the floating fixing component being mounted to the target object by first extending the retaining section through the expanded receiving area on the target object and then moving the neck portion of the retaining section into the intermediate area on the target object, and finally moving the clamped portion of the retaining section into the narrowed holding area on the target object.

15. The floating fixing component according to claim 11, further comprising at least one fastening section for holding the retaining section to at least one narrowed holding area on the target object and for holding the retaining section to at least one locating area on the target object to restrict the retaining section from moving laterally, vertically or rotationally relative to the target object; or for abutting against or interfering with a surface of the target object to thereby restrict the retaining section from moving laterally, vertically or rotationally relative to the target object.

16. The floating fixing component according to claim 11, further comprising at least one fastening section, which is an elastic fastener having an elastic arm.

17. The floating fixing component according to claim 11, wherein the retaining section includes an anti-rotation section corresponding to a matching anti-rotation section on the target object.

18. The floating fixing component according to claim 11, wherein the retaining section and the target object have a floating space existed between them, such that the floating fixing component can float and shift on and relative to the target object.

19. A floating fixing component, comprising a retaining section and at least one stop section; the stop section being extended through an expanded receiving area on an object and the retaining section being further moving into a narrowed holding area on the object, such that the floating fixing component is limited by the stop section from moving relative to the object; and the retaining section having an outer diameter smaller than that of the narrowed holding area while the stop section having an outer diameter larger than that of the narrowed holding area.

20. A floating fixing component, comprising at least one expanded receiving area and at least one narrowed holding area; the floating fixing component being mounted to an object by moving the at least one expanded receiving area through at least one stop section on the object and then moving the at least one narrowed holding area to engage with at least one retaining section on the object, such that the at least one stop section restricts the floating fixing component from moving relative to the object.
